(19) United States
(12) Patent Application Publication
(10) Pub. No.: US 2023/0281319 A1
(43) Pub. Date: Sep. 7, 2023

(54) METHODS, SYSTEMS, AND COMPUTER READABLE MEDIA FOR AUTOMATICALLY GENERATING COMPARTMENTALIZATION SECURITY POLICIES AND RULE PREFETCHING ACCELERATION FOR TAGGED PROCESSOR ARCHITECTURES

(71) Applicant: The Trustees of the University of Pennsylvania, Philadelphia, PA (US)

(72) Inventors: Andre Maurice DeHon, Philadelphia, PA (US); Nicholas Edward Roessler, Philadelphia, PA (US)

(21) Appl. No.: 18/113,254

(22) Filed: Feb. 23, 2023

Related U.S. Application Data
(60) Provisional application No. 63/313,082, filed on Feb. 23, 2022.

(51) Int. Cl. G06F 21/57

(52) U.S. Cl. CPC G06F 21/577; G06F 2221/033

(57) ABSTRACT

Methods, systems, and computer readable media for generating compartmentalization security policies and/or methods, systems, and computer readable media for generating prefetching policies for rule caches associated with tagged processor architectures are provided. An example method occurs at a node for generating compartmentalization security policies for tagged processor architectures. The method comprises: receiving computer code of at least one application; determining, using a compartmentalization algorithm, at least one rule cache characteristic, and performance analysis information, compartmentalizations for the computer code and rules for enforcing the compartmentalizations; generating a compartmentalization security policy comprising the rules for enforcing the compartmentalizations; and instantiating, using a policy compiler, the compartmentalization security policy for enforcement in the tagged processor architecture, wherein instantiating the compartmentalization security policy includes tagging an image of the computer code of the at least one application based on the compartmentalization security policy.

### CROSS-REFERENCE TO RELATED APPLICATIONS

This application claims the benefit of U.S. Provisional Patent Application Ser. No. 63/313,082, filed Feb. 23, 2022, the disclosure of which is incorporated herein by reference in its entirety.

### GOVERNMENT INTEREST

This invention was made with government support under HR0011-18-C-0011 awarded by Department of Defense and 1513854 awarded by the National Science Foundation. The government has certain rights in the invention.

### TECHNICAL FIELD

This specification relates generally to metadata processing systems for tagged processor architectures. More specifically, the subject matter relates to methods, systems, and computer readable media for automatically generating compartmentalization security policies for tagged processor architectures and/or methods, systems, and computer readable media for generating prefetching policies for rule caches associated with tagged processor architectures.

### BACKGROUND

Modern software stacks are notoriously vulnerable. Operating systems, device drivers, and countless applications, including most embedded applications, are written in unsafe languages and run in large, monolithic protection domains where any single vulnerability may be sufficient to compromise an entire machine. Privilege separation is a defensive approach in which a system is separated into components, and each is limited to (ideally) just the privileges it requires to operate. In a such a separated system, a vulnerability in one component (e.g., the networking stack) is isolated from other system components (e.g., sensitive process credentials), making the system substantially more robust to attackers, or at least increasing the effort of exploitation in cases where it is still possible.

Recently, some systems have demonstrated the value of propagating metadata during execution to enforce policies that catch safety violations and malicious attacks as they occur. These policies can be enforced in software, but typically with high overheads that discourage their deployment or motivate coarse approximations providing less protection. Hardware support for fixed policies can often reduce the overhead to acceptable levels and prevent a large fraction of today's attacks. However, attacks rapidly evolve to exploit any remaining forms of vulnerability.

One mechanism for helping to resolving some of these issues may involve using a programmable unit for metadata processing (PUMP) system. A PUMP system may indivisibly associate a metadata tag with every word in the system's main memory, caches, and registers. To support unbounded metadata, the tag may be large enough to point or indirect to a data structure in memory. On every instruction, the tags of the inputs can be used to determine if the operation is allowed, and if so to determine the tags for the results. The tag checking and propagation rules can be defined in software; however, to minimize performance impact, these rules may be cached in a hardware structure, the PUMP rule cache, that operates in parallel with an arithmetic logic unit (ALU). A software miss handler may service cache misses based on the policy rule set currently in effect.

However, a simple, direct implementation of a PUMP system can be rather expensive. Further, while the principle of least privilege is a powerful guiding force in secure system design, in practice it is often at odds with system performance. Given the limited hardware resources that have been allocated for security, privilege separation has typically relied on coarse-grained, process-level separation in which the virtual memory system is used to provide isolation. Furthermore, implementing privilege separation in a PUMP or metadata processing system can be tedious, error-prone, and resource intensive, especially if such implementation requires significant human involvement for identifying and fine-tuning protection domains.

### SUMMARY

Methods, systems, and computer readable media for generating compartmentalization security policies for tagged processor architectures and/or methods, systems, and computer readable media for generating prefetching policies for rule caches associated with tagged processor architectures are provided. A method occurs at a node for generating compartmentalization security policies for tagged processor architectures. The method comprises: receiving code of at least one application; determining, using a compartmentalization algorithm, at least one rule cache characteristic, and performance analysis information, compartmentalizations for the code and rules for enforcing the compartmentalizations; generating a compartmentalization security policy comprising the rules for enforcing the compartmentalizations; and instantiating, using a policy compiler, the compartmentalization security policy for enforcement in the tagged processor architecture, wherein instantiating the compartmentalization security policy includes tagging an image of the code of the at least one application based on the compartmentalization security policy.

A system for generating compartmentalization security policies for tagged processor architectures includes one or more processors; and a node for generating compartmentalization security policies for tagged processor architectures implemented using the one or more processors and configured for: receiving code of at least one application; determining, using a compartmentalization algorithm, at least one rule cache characteristic, and performance analysis information, compartmentalizations for the code and rules for enforcing the compartmentalizations; generating a compartmentalization security policy comprising the rules for enforcing the compartmentalizations; and instantiating, using a policy compiler, the compartmentalization security policy for enforcement in the tagged processor architecture, wherein instantiating the compartmentalization security policy includes tagging an image of the code of the at least one application based on the compartmentalization security policy.

The subject matter described herein may be implemented in software in combination with hardware and/or firmware. For example, the subject matter described herein may be implemented in software executed by a processor. In one example implementation, the subject matter described herein may be implemented using a computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, and application-specific integrated circuits. In addition, a computer readable medium that implements the subject matter described herein may be located on a single device or computing platform or may be distributed across multiple devices or computing platforms.

As used herein, the term “node” refers to at least one physical computing platform including one or more processors and memory.

As used herein, each of the terms “function”, “engine”, and “module” refers to hardware, firmware, or software in combination with hardware and/or firmware for implementing features described herein.

### BRIEF DESCRIPTION OF THE DRAWINGS

Embodiments of the subject matter described herein will now be explained with reference to the accompanying drawing, wherein like reference numerals represent like parts, of which:

FIG. 1 depicts example output from a tracing policy indicating privileges needed by traced functions to execute;

FIGS. 2A-H depict a set of graphs indicating impact of clustering algorithms on an hypertext transfer protocol (HTTP) web server running on a 1024-entry rule cache;

FIG. 3 depicts an example of merging working set domains to reduce the number of rules;

FIG. 4A is a diagram illustrating impact of the WSₘₐₓ parameter on a rule cache miss rate for a 1,024-entry rule cache;

FIG. 4B depicts privilege-performance plots for five different applications generated from the both the Domain-Size algorithm and the Working-Set algorithm;

FIGS. 5A-B depict privilege-performance plots indicating impact of Syntactic Domains and Constraints on an HTTP web server running on a 1024-entry rule cache;

FIGS. 6A-B shows an example function and a corresponding Rule-Successor Graph usable in prefetching decisions;

FIG. 7A depicts how much prefetching is possible based on the minimum probability of a prefetched rule being used;

FIG. 7B depicts privilege-performance plots indicating impact of prefetching policies on overprivilege ratio (OR) for two applications;

FIG. 8 depicts aspects associated with an exploitable vulnerability in a web server application;

FIG. 9 is a diagram illustrating an exemplary node for generating compartmentalization security policies for tagged processor architectures;

FIG. 10 is a flowchart of an example method for generating compartmentalization security policies for tagged processor architectures;

FIG. 11 is a flowchart illustrating an example method for generating prefetching policies for rule caches associated with tagged processor architectures; and

FIG. 12 is a diagram illustrating an example tagged processor node for executing security and prefetching policies.

### DETAILED DESCRIPTION

This subject matter described herein relates to methods, systems, and computer readable media for generating compartmentalization security policies for tagged processor architectures and/or methods, systems, and computer readable media for generating prefetching policies for rule caches associated with tagged processor architectures.

We present Secure Compartments Automatically Learned and Protected by Execution using Lightweight metadata (SCALPEL), a tool for automatically deriving compartmentalization policies and lowering them to a tagged architecture for hardware-accelerated enforcement. SCALPEL allows a designer to explore high-quality points in the privilege-reduction vs. performance overhead tradeoff space using analysis tools and a detailed knowledge of the target architecture to make best use of the available hardware. SCALPEL automatically implements hundreds of compartmentalization strategies across the privilege-performance tradeoff space, all without manual tagging or code restructuring. SCALPEL uses two novel optimizations for achieving highly performant policies: the first is an algorithm for packing policies into working sets of rules for favorable rule cache characteristics, and the second is a rule prefetching system that allows us to exploit the highly predictable nature of compartmentalization rules. SCALPEL uses a new algorithm for packing policies into working sets of rules for favorable cache characteristics on a tagged architecture. We implement SCALPEL on a FreeRTOS stack, a realistic context for embedded systems, and one in which the OS and application share a single monolithic address space. We target a tag-extended RISC-V core and evaluate architectural behavior on a range of applications, including an HTTP web server implementation, an h264 video encoder, the GNU Go engine, and the libXML parsing library. Our results show that SCALPEL-created policies can reduce overprivilege by orders of magnitude with hundreds of logical compartments while imposing low overheads (<5%).

### 1. Introduction

Privilege separation is a defensive approach in which a system is separated into components, and each is limited to (ideally) just the privileges it requires to operate. In a such a separated system, a vulnerability in one component (e.g., the networking stack) is isolated from other system components (e.g., sensitive process credentials), making the system substantially more robust to attackers, or at least increasing the effort of exploitation in cases where it is still possible.

However, the prevailing wisdom has been that only coarse-grained privilege separation is feasible in practice given the high cost of virtual memory context switching. Indeed, all modern OSs run on insecure but performant monolithic kernels, with more functionality frequently moving into the highly-privileged kernel to reduce such costs; privilege separated microkernels, in contrast, remain plagued with the perception of high overheads and have seen little adoption. IoT and embedded systems—which we now find ourselves surrounded by in our every-day lives—have fallen even farther behind in security than their general-purpose counterparts. They are also written in memory unsafe languages, typically C, often lack basic modern exploit mitigations, and many run directly on bare metal with no separation between any parts of the system at all.

There has recently been a surge of interest—both academic and in industry—in architectural and hardware support for new security primitives. For example, ARM recently announced that it will integrate hardware capability support (CHERI) into its chip designs, Oracle has released SPARC processors with coarse-grained memory tagging support (ADI), and NXP has announced it will use Dover's CoreGuard, among many others. One interesting and practical use case for these primitives is privilege separation enforcement. In this chapter we build privilege separation policies for a fine-grained, hardware-accelerated security monitor design (the PIPE architecture). While we focus on the PIPE and an embedded FreeRTOS, the core ideas are applicable to other architectures and runtime environments.

A flexible, tag-based hardware security monitor, like the PIPE, provides an exciting opportunity to enforce fine-grained, hardware-accelerated privilege separation. At a bird's-eye view, one can imagine using metadata tags on code and data to encode logical protection domains, with rules dictating which memory operations and control-flow transitions are permitted. The PIPE leaves tag semantics to software interpretation, meaning one can express policies ranging from coarse-grained decompositions, such as a simple separation between “trusted” and “untrusted” components, to hundreds or thousands of isolated compartments depending on the privilege reduction and performance characteristics that are desired.

To explore this space, we present SCALPEL(Secure Compartments Automatically Learned and Protected by Execution using Lightweight metadata), a tool that enables the rapid self-learning of low-level privileges and the automatic creation and implementation of compartmentalization security policies for a tagged architecture. At its back-end, SCALPEL contains a policy compiler that decouples logical compartmentalization policies from their underlying concrete enforcement with the PIPE architecture. The back-end takes as input a particular compartmentalization strategy, formulated in terms of C-level constructs and their allowed privileges, and then automatically tags a program image to instantiate the desired policy. To ease policy creation and exploration, the SCALPEL front-end provides a tracing mode, compartment-generation algorithms, and analysis tools, to help an engineer quickly create, compare and then instantiate strategies using the back-end. These tools build on a range of similar recent efforts that treat privilege assessment quantitatively and compartment generation algorithmically, allowing SCALPEL's automation to greatly assist in the construction of good policies, a task that would otherwise be costly in engineering time. In cases where human expertise is available for additional fine-tuning, SCALPEL easily integrates human supplied knowledge in its policy exploration; for example, a human can add additional constraints to the algorithms, such as predefining a set of boundaries or specifying that a particular object is security-critical and should not be exposed to additional, unnecessary code.

Additionally, SCALPEL presents two novel techniques for optimizing security policies to a tagged architecture. The first is a policy-construction algorithm that directly targets the rule cache characteristics of an application: the technique is based on packing sets of rules needed for different program phases into sets that can be cached favorably. While we apply this technique on SCALPEL's compartmentalization policies, the core idea could be used to improve the performance of other policies on tagged architectures. Additionally, we show that this same technique can be used to pack an entire policy into a fixed-size set such that no rule cache misses will be taken besides compulsory misses—this makes it possible to achieve real-time guarantees while using a hardware security monitor like the PIPE, which may be of particular value to embedded, real-time devices and applications. Secondly, we design and evaluate a rule prefetching system that exploits the highly-predictable nature of compartmentalization rules; by intelligently prefetching rules before they are needed, we show that the majority of stalled cycles spent waiting for policy evaluation can be avoided.

We evaluate SCALPEL and its optimizations on a typical embedded, IoT environment consisting of a FreeRTOS stack targeting a PIPE-extended RISC-V core. We implement our policies on several applications, including an hypertext transfer protocol (HTTP) web server, an H264 video encoder, the GNU Go engine, and the libXML parsing library. Using SCALPEL, we show how to automatically derive compartmentalization strategies for off-the-shelf software that balance privilege reduction with performance, and that hundreds of isolated compartments can be simultaneously enforced with acceptable overheads on a tagged architecture.

To summarize, SCALPEL combines (1) hardware support for fine-grained metadata tagging and policy enforcement with (2) compartmentalization and privilege analysis tools, which together allow a thorough exploration of the level of privilege separation that can be achieved with hardware tagging support. Our primary contributions are:
A tool that automatically creates and instantiates tag-based compartmentalization policies on real software without manual refactorings.
Compartment-generation algorithms and analysis tools that quantify the privilege exposure and performance of a wide range of automatically-generated compartmentalization alternatives, providing the security engineer with a variety of privilege-performance design points to explore and evaluate.
New techniques for using a tagged architecture for the rapid self-learning of privileges on unmodified software.
A new technique for optimizing a security policy to a tagged architecture by directly targeting its rule cache characteristics.

### 2. Related Work

2.1 The PIPE Architecture

Tag-based hardware security monitors can be used to improve software security by detecting and preventing violations of security policies at runtime. The PIPE (Processor Interlocks for Policy Enforcement) is a software/hardware co-designed processor extension for hardware-accelerated security monitor enforcement. The core idea is that word-sized metadata tags are associated with data words in the system, including on register values, words stored in memory, and also on the program counter. As each instruction executes on the primary processor core (referred to as the application or AP core), the tags relevant to the instruction are used to validate the operation against a software security monitor, typically in parallel with instruction execution.

This policy evaluation is performed on a dedicated coprocessor, the policy execution (PEX) core. The semantics of tags are entirely determined by how the policy software interprets the tag bits, allowing the expression of a rich range of security policies. The software monitor determines if a particular set of tags represents a valid operation, and if so, it also produces new tags for the result words of that operation. Prior work has shown this model can express a range of useful security policies, such as heap safety, stack safety, dynamic tainting, control-flow integrity, and information-flow control.

To accelerate the behavior of the software security monitor, an implementation of the PIPE architecture will include a hardware cache of metadata rules. When a rule misses in the cache, it is evaluated on the PEX core and then inserted into the rule cache. In the future, when a rule hits in the cache, it can be validated without re-executing the monitor software or interpreting the tag bits. This means that if the cache hit rate is high, the processor can run with little performance impact resulting from policy enforcement. To keep the hit rate high, policies should be designed with temporal locality in mind. For privilege separation compartmentalization policies, this property will be driven by the number of identifiers that are used for encoding protection domains on code and data objects, as well as their temporal locality characteristics. This interplay of policy design and architecture is explored in Section 7.

Lastly, we note that the privilege separation policies we derive could likely be ported to other tagged architectures such as Oracle ADI, LBA, Harmoni, or FADE; however, SCALPEL uses the PIPE and its architectural characteristics for concrete evaluation.

2.2. The Protection-Performance Tradeoff

While the PIPE can express memory safety policies, fine-grained enforcement of all memory accesses can become expensive for some workloads. Compartmentalization policies represent an alternative design point that can very flexibly tune performance-protection tradeoffs through changing compartment sizes and intelligently drawing boundaries for high-performance. With a small number of tags, one can separate out trusted from untrusted components such as ARM TrustZone or OS from the application as in, but ultimately we are interested in exploring finer-grained separations. For example, we can explore how tightly we can compartmentalize a software system with tag support while maintaining a certain rule cache hit rate, say 99.9%.

Walking the line between protection and overhead costs is a well-known problem space. Dong et al. observed that different decomposition strategies for web browser components produced wildly different overhead costs, which they manually balanced against domain code size or prior bug rates. Mutable Protection Domains proposes dynamically adjusting separation boundaries in response to overhead with a custom operating system and manually engineered boundaries. Several recent works have proposed more quantitative approaches to privilege separation. Program-Mandering uses optimization techniques to find good separation strategies that balance reducing sensitive information flows with overhead costs, but requires manual identification of sensitive data, and ACES similarly measures the average reduction in write exposure to global variables as a property of compartmentalizations. While these systems begin to automate portions of the compartment formation problem that SCALPEL builds upon, they all still rely on manual input. SCALPEL takes a policy derivation approach with a much stronger emphasis on automation: it uses analysis tools and performance experiments to explore the space of compartmentalizations, then automatically optimizes and lowers them to its hardware backend, a tag-extended RISC-V architecture, for enforcement.

2.3 Automatic Privilege Separation

The vast majority of compartmentalization work to date has been manual, demanding a security expert manually identify and refactor the code into separate compartments. This includes the aforementioned projects like OpenSSH and Dovecot, and even MicroKernel design using standard OS process isolation, and run-time protection for embedded systems with using metadata tags. Academic compartmentalization work has also relied on manual or semi-manual techniques for labeling and partitioning.

In contrast, one goal for SCALPEL is automation; that is, to apply tag-based privilege-separation defenses to applications without expensive refactorings or manual-tagging; automated efforts relieve the labor-intensive costs of prior manual compartmentalization frameworks. Additionally, automation is important to ease the difficulty of integrating existing software with the PIPE—SCALPEL decouples policy creation from enforcement by automatically lowering an engineer's C-level compartmentalization strategies to the instruction-level enforcement provided by the PIPE.

ACES is an automated compartmentalization tool for embedded systems and shares similarities with SCALPEL. It begins with a program dependence graph (PDG) representation of an application and a security policy (such as Filename, or one of several other choices), which indicates a potential set of security boundaries. It then lowers the enforcement of the policy to a target microcontroller device to meet performance and hardware constraints. The microcontroller it targets supports configurable permissions for eight regions of physical memory using a lightweight MPU; protection domains in the desired policy are merged together until they can be enforced with these eight regions. Unlike ACES, SCALPEL targets a tagged architecture to explore many possible policies, some of which involve hundreds of protection domains, for fine-grained separation, far beyond what can be achieved with the handful of segments supported by conventional MPUs.

Towards Automatic Compartmentalization of C Programs on Capability Machines is also similar to SCALPEL. In this work, the compiler translates each compilation unit of an application into a protection domain for enforcement with the CHERI capability machine. This allows finer-grained separation than can be afforded with a handful of memory segments, but provides no flexibility in policy exploration to tune performance and security characteristics like SCALPEL does. To summarize, SCALPEL is a complete tool for automatically compartmentalizing unmodified software for hardware acceleration, including automatically self-learning the required privileges, systematically exposing the range privilege-performance design points through algorithmic exploration, and optimizing policies for good rule cache performance. It complements and extends prior work along four axes: (1) quantitatively scoring the overprivilege in compartmentalization strategies, (2) providing complete automatic generation of compartments without manual input, (3) offering decomposition into much larger numbers of compartments (hundreds to thousands), and (4) automatically identifying the privilege-performance tradeoff curves for a wide-range of compartmentalization options.

### 3. Threat Model

We assume a standard but powerful threat model for conventional C-based systems, in which an attacker may exploit bugs in either FreeRTOS or the application to gain read/write primitives on the system, which they may use to hijack control-flow, corrupt data, or leak sensitive information. Attackers supply inputs to the system, which, depending on the application, may include through a network connection or through files to be parsed or encoded. We assume both FreeRTOS and the application are compiled statically into a single program image with no separation before our compartmentalization; as such, a vulnerability in any component of the system may lead to full compromise. We assume that FreeRTOS and the application are trusted, but may otherwise contain bugs.

The protection supplied by SCALPEL isolates memory read and write instructions to the limited subset of objects dictated by the policy, and also limits program control-flow operations to valid entry points within domains as dictated by the policy. Additionally, SCALPEL is composed with a W⊕E tag memory permissions policy, meaning attackers cannot inject new executable code into the system. These constraints prevent bugs from reaching the full system state and limit the impacts of attacks to their contained compartments.

### 4. Compartmentalization Tag Policy Formulation

In this section we sketch our general policy model for compartmentalizing software using a tagged architecture. The goal of the compartmentalization policies is to decompose a system into separate logical protection domains, with runtime enforcement applied to each to ensure that memory accesses and control-flow transfers are permitted according to the valid operations granted to that domain. How do we enforce policies like these with a tagged architecture?

The PIPE provides hardware support for imposing a security monitor on the execution of each instruction. Whether or not each instruction is permitted to execute can depend on the tags on the relevant pieces of architectural state (Section 2.1). For example, we may have a stored private key that should only be accessible to select cryptographic modules. We can mark the private key object with a private_key tag and the instructions in the signing function with a crypto_sign tag. Then, when the signing function runs and the PIPE sees a load operation with instruction tag crypto_sign and data tag private_key, it can allow the operation. However, if a video processing function whose instructions are labeled video_encode tries to access the private_key, the PIPE will see a load operation with instruction tag video_encode and data tag private_key and disallow the invalid access.

In general, to enable compartmentalization policies, we place a Domain-ID label on each instruction in executable memory indicating the logical protection domain to which the instruction belongs; this enables rules to conditionally permit operations upon their tagged domain grouping, which serves as the foundation for dividing an application's code into isolated domains. Similarly, we tag each object with an Object-ID to demarcate that object as a unique entity onto which privileges can be granted or revoked. For static objects, such as global variables and memory mapped devices, these object identifiers are simply placed onto the tags of the appropriate memory words at load time. Objects that are allocated dynamically (such as from the heap), require us to decide how we want to partition out and grant privileges to those objects. We choose to identify all dynamic objects that are allocated from a particular program point (e.g., a call to malloc) as a single object class, which we will refer to simply as an object. For example, all strings allocated from a particular char*name=malloc(16) call are the same object from SCALPEL's perspective; this formulation is particularly well-suited to the PIPE because it enables rules in the rule cache to apply to all such dynamic instances. It also means that all dynamic objects allocated from the same allocation site must be treated the same way in terms of their privilege—dynamic objects could be differentiated further (such as by the calling context of the program point) to provide finer separation, but we leave such exploration to future work. As a result of these subject and object identification choices, the number of subjects and objects in a system is fixed at compile time.

Between pairs of subjects and objects (or in the case of a call or return, between two subjects), we would like to grant or deny operations. Accordingly, the tag on each instruction in executable memory also includes an opgroup field that indicates the operation type of that instruction. We define four opgroups and each instruction is tagged with exactly one opgroup: read, write, call, and return. For example, in the RISC-V ISA, the sw, sh, sb, etc. instructions would compose the write opgroup.

When an instruction is executed, the security monitor determines if the operation is legal based upon (1) the Domain-ID of the executing instruction, (2) the type of operation op e {read,write,call,return} being executed, and (3) the Object-ID of the accessed word of memory (for loads and stores), or the Domain-ID of the target instruction (for calls and returns). As a result, the set of permitted operations can be expressed as a set of triples (subject, operation, object) with all other privileges revoked (default deny). In this way, the security monitor check can be viewed as a simple lookup into a privilege table or access-control matrix whose dimensions are set by the number of Domain-IDs, Object-IDs and the four operation types. Such a check can be efficiently implemented in the security monitor software as single hash table lookup; once validated in software, a privilege of this form is represented as a single rule that is cached in the PIPE rule cache for hardware-accelerated, single-cycle privilege validation. Additionally, we define a fifth unprivileged opgroup, which is placed on instructions that do not represent privileges in our model (e.g., add); these instructions are always permitted to execute.

We define a compartmentalization as an assignment of each instruction to a Domain-ID, an assignment of each object to an Object-ID, and a corresponding set of permitted operation triples (Domain-ID, op, Object-ID). The SCALPEL backend takes a compartmentalization as an input and then automatically lowers it to a tag policy kernel suitable for enforcement with the PIPE. In this way, SCALPEL decouples policy construction from the underlying tag enforcement. The opgroup mapping is the same across all compartmentalizations.

In addition to these privilege checks, the SCALPEL backend also applies three additional defenses to support the enforcement of the compartmentalization. The first is a W⊕X policy that prevents an attacker from injecting new executable code into the system. The second is that the words of memory inside individual heap objects that store allocator metadata (e.g., the size of the block) are tagged with a special ALLOCATOR tag. The allocator itself is placed in a special ALLOCATOR compartment that is granted the sole permission to access such words; as a result, sharing heap objects between domains permits only access to the data fields of those objects and not the inline allocator metadata. Lastly, SCALPEL uses LLVM's static analysis to compute the set of instructions that are valid call and return entry points. These are tagged with special CALL-TARGET and RETURN-TARGET tags, and we apply additional clauses to the rules to validate that each taken control-flow transfer is both to a permitted domain and to a legal target instruction; this means that when a call or return privilege is granted, it is only granted for valid entry and return points.

An advantage of this policy design is that privilege enforcement is conducted entirely in the tag plane and software does not require refactoring to be protected with SCALPEL. Lastly, we note that there are multiple ways to encode compartmentalization policies on a tagged architecture. For example, the current compartment context could be stored on the program counter tag and updated during domain transitions, rather than from being inferred from the currently executing code. Some of these alternate formulations may work better with different concrete tagging architectures. However, for the PIPE, these formulations are largely equivalent to the above static formulation combined with localizing code into compartments (and making some decisions about object ownership), and we choose the static variant for a slight reduction in policy complexity; the choice is not particularly significant and SCALPEL could produce policies for many such formulations.

### 5. The Tracing Policy

While a motivated developer or security engineer could manually construct a compartmentalization for a particular software artifact and provide it to the SCALPEL back-end, SCALPEL seeks to assist in policy derivation by providing a tracing mode (similar to e.g., AppArmor) as well as a set of analysis tools for understanding the tradeoffs in different decomposition strategies. To this end, we build a compartmentalization tracing policy, which collects a lower-bound on the privileges exercised by a program as well as rule cache statistics we use later for policy optimization. While the PIPE architecture was designed for enforcing security policies, in this case we repurpose the same mechanism for fine-grained, programmable dynamic analysis. SCALPEL's tracing policy has several significant practical advantages over other approaches by (1) greatly simplifying tracing by running as a policy replacement on the same hardware and software, (2) directly using the PIPE for hardware-accelerated self-learning of low-level privileges (3), and making it possible to run in real environments and on unmodified software.

For the tracing policy, code and objects should be labeled at the finest granularity at which a security engineer may later want to decompose them into separate domains. On the code side, we find that function-level tracing provides a good balance of performance and precision, and so in this work SCALPEL tags each function with a unique Domain-ID during tracing. As a result, our SCALPEL implementation considers functions to be the smallest unit of code that can be assigned to a protection domain. Note that this is a design choice, and the PIPE could collect finer-grained (instruction-level) privileges at a higher cost to the tracing overhead.

On the object side, the tracing policy also assigns an Object-ID to each primitive object in the system. For software written in C, this includes a unique Object-ID for each global variable, a unique Object-ID for each memory-mapped device/peripheral in the memory map (e.g., Ethernet, UART), and a unique Object-ID associated with each allocation call site to an allocator as discussed in Section 4. All data memory words in a running system receive an Object-ID from one of these static or dynamic cases.

With these identifiers in place, the tracing policy is then used to record the observed dynamic behavior of the program. The PIPE invokes a software miss handler when it encounters a rule that is not in the rule cache. When configured as the tracing policy, the miss handler simply records the new privileges it encounters—expressed as interactions of Domain-IDs, operation types, and Object-IDs—as valid privileges that the program should be granted to perform; it then installs a rule so the program can use that privilege repeatedly without invoking the miss handler again. Unlike other policies, the tracing policy never returns a policy violation.

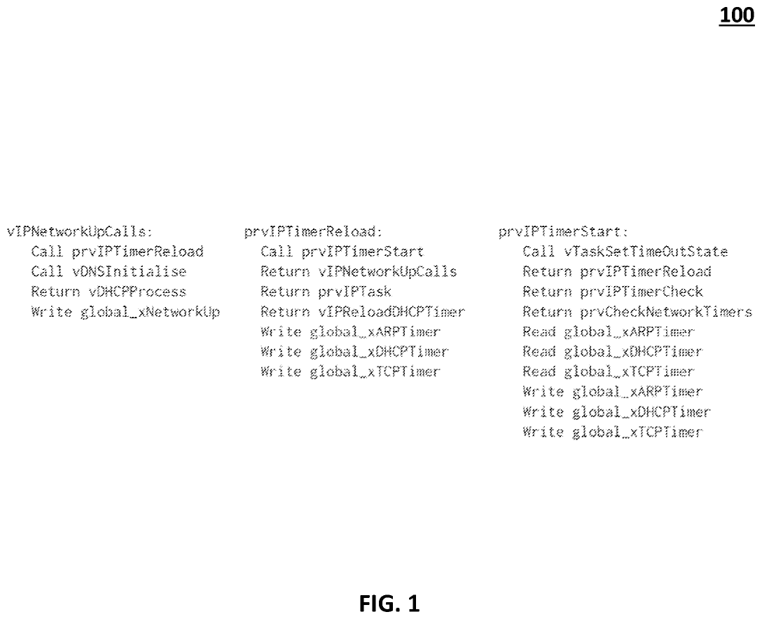

FIG. 1 depicts example output 100 from a tracing policy indicating privileges needed by traced functions to execute. For example, after using a tracing policy to trace a program or a function thereof, output 100 may include various learned or derived information about the traced program/function. Example learned or derived information may include function(s) called by the traced program/function, function(s) the traced program/function may return, data the traced program/function may read or access, and data the traced program/function may write or modify. In this example, output 100 may list all privileges required for execution of the traced program/function, but may not list a privilege (e.g., privilege access) if that privilege is not required for execution of the traced program/function. As shown, output 100 includes a set of privileged operations recorded by the tracing policy for three functions in the FreeRTOS TCP/IP networking stack with identifiers depicted as strings from their source program objects. SCALPEL uses a tag-based hardware security monitor to automatically self-learn and then enforce fine-grained privileges like these at runtime. We discuss the limitations of dynamic analysis and SCALPEL's runtime modes in Section 13.

In addition to collecting privileges, the tracing policy also periodically records the rules that were encountered every Nepoch instructions, which we set to one million (M). As we'll see in later sections, this provides the SCALPEL analysis tools with valuable information about rule co-locality which it uses to construct low-overhead policies.

### 6. Privilege Quantification Model

In practice, one likely wants to deploy compartmentalizations that are coarser than the tracing policy granularity (i.e., individual functions and C-level objects) to reduce the number of tags, rules and thus runtime costs associated with policy enforcement. Importantly, the tracing policy leads to a natural privilege quantification model we can use to compare these relaxed decompositions against the finest-grained function/object granularity. We can think of each rule in the tracing policy (Domain-ID, op, Object-ID) as a privilege, to which we can assign a weight. The least privilege of an application is the sum of the lower-bound privileges that it requires to run; without any of these, the program could not perform its task. For any coarser-grained compartmentalization, we can compute its privilege by counting up the number of fine-grained privileges it permits, which will include additional privileges beyond those in the least-privilege set. This enables us to compute the overprivilege ratio (OR), which we define as the ratio of the privileges allowed by a particular compartmentalization compared to the least-privilege minimum; i.e., an OR of 2.0 means that twice as many privileges are permitted as strictly required. While crude, the OR provides a useful measure of how much privilege decomposition has been achieved, both to help understand where various compartmentalization strategies lie in the privilege-performance space and as an objective function for SCALPEL automatic policy derivation. For our weighting function, we choose to weight each object and function by its size in bytes; this helps account for composite data structures such as a struct that may have multiple fields and should count for additional privilege. Optionally, a developer can manually adjust the weights of functions or objects relative to other components in the system and interactively rerun the algorithms to easily tune the produced compartmentalizations.

### 7. Policy Exploration

To assist in creating and exploring compartment policies, SCALPEL provides three compartment generation algorithms. The first and simplest such approach, presented in Section 7.1, generates compartment boundaries based upon the static source code structure, such as taking each compilation unit or source code file as a compartment. The second algorithm, presented in Section 7.2, instead takes an algorithmic optimization approach that uses the tracing data to group together collections of mutually interacting functions. This algorithm is parameterized by a target domain size, allowing it to expose many design points, ranging from hundreds of small compartments to several large compartments. This is an architecture-independent approach that broadly has the property that larger compartments need fewer rules that will compete for space in the rule cache. Lastly, in Section 7.3 we present a second algorithmic approach that specifically targets producing efficient policies for the PIPE architecture; it targets packing policies into working sets of rules for improved cache characteristics. This algorithm uses both the tracing data and the cache co-locality data (Section 5) to produce optimized compartmentalization definitions, and is the capstone algorithm proposed in SCALPEL.

7.1 Syntactic Compartments

A simple and commonly-used approach for defining compartment boundaries is to mirror the static source code structure into corresponding security domains—we call these the syntactic domains. We define the OS syntactic domain by placing all of the FreeRTOS code into one compartment (Domain-ID1) and all of the application code into a second compartment (Domain-ID2). This decomposition effectively implements a kernel/userspace separation for an embedded application that does not otherwise have one. Similarly, the directory syntactic domains are constructed by placing the code that originates from each directory of source code into a separate domain, e.g., Domain-ID i is assigned to the code generated from the ith directory of code. Programmers typically decompose large applications into separate, logically-isolated-but-interacting modules, and the directory domains implement these boundaries for such systems. Lastly, the file and function syntactic domains are constructed by assigning a protection domain to each individual source code file or function that composes the program. Note that each syntactic domain is a strict decomposition from the one before it; for example, compilation units are a sub-decomposition of the OS/application boundary.

For the syntactic compartments, objects are labeled at the fine, individual object granularity (a fresh Object-ID for each global variable and heap allocation site); afterwards, all objects with identical permission classes based upon the tracing data are merged together. For example, if two global variables are accessed only by Domain-ID1, then they can be joined into a single Object-ID with no loss in privilege; however, if one is shared and one is not, then they must be assigned separate Object-IDs to encode their differing security policies.

A second use we find for the syntactic code domains is applying syntactic constraints to other algorithms: for example, we can generate compartments algorithmically but disallow merging code across compilation units to maintain interfaces and preserve the semantic module separation introduced by the programmer. These results are presented in Section 9.4.

7.2 Domain-Size Compartments

While the syntactic domains allow us to quickly translate source code structure into security domains, we are ultimately interested in exploring privilege-performance tradeoffs in a more systematic and data-driven manner than can be provided by the source code itself. We observe that the output of the tracing policy (Section 5) is a rich trove of information—a complete record of the code and object interactions including their dynamic runtime counts—on top of which we can run optimization algorithms to produce compartments.

Because optimal clustering is known to be NP-Hard, we employ a straightforward greedy clustering algorithm that groups together sets of mutually-interacting functions into domains while reducing unnecessary overprivilege. The algorithm is parameterized by Cₘₐₓ, the maximum number of bytes of code that are permitted per cluster. The algorithm works as follows: upon initialization, each function is placed into a separate compartment Cᵢ with size Cᵢ_{_{size}} taken to be the size (in bytes) of that function. At each step of the algorithm, two compartments C_{A} and C_{B} are chosen to merge together; the size of the resulting compartment is simply the sum of the sizes of the compartments being merged: C_{AB}_{_{size}}=C_{A}_{_{size}}+C_{B}_{_{size}}. To determine which two compartments to merge at each merge step, we compute the ratio of a utility function to that of a cost function for all pairs and select the pair with the highest ratio. The utility function we use is the number of cross-compartment calls and returns found by the tracing policy between those two compartments (i.e., their call affinity). The cost function we use is the increase in privilege (as given by Section 6) that would result from the merge: that is, we would like to identify mutually interacting functions with high affinity and group them together, while reducing unnecessary overprivilege. The algorithm terminates when no legal merges remain; that is, no candidates A and B maintain C_{A}_{_{size}}+C_{B}_{_{size}}≤Cₘₐₓ.

After completion, each cluster Cᵢ is translated into security domain Domain-IDi and objects are processed in the same manner as described in Section 7.1.

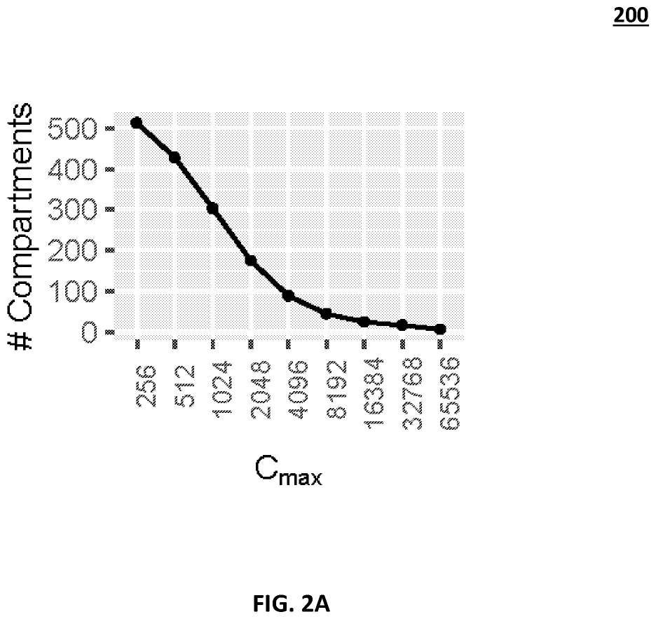

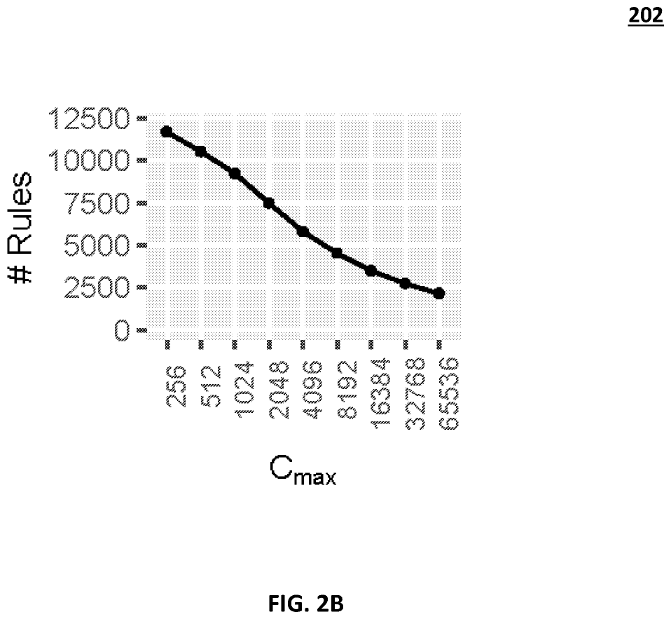

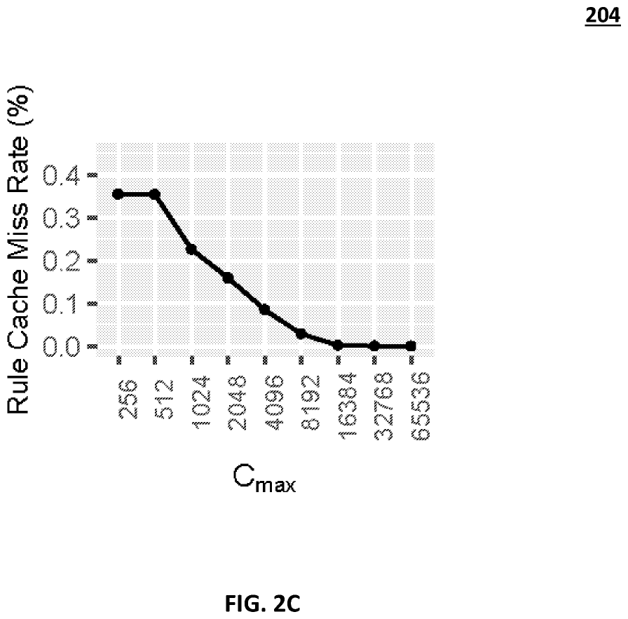

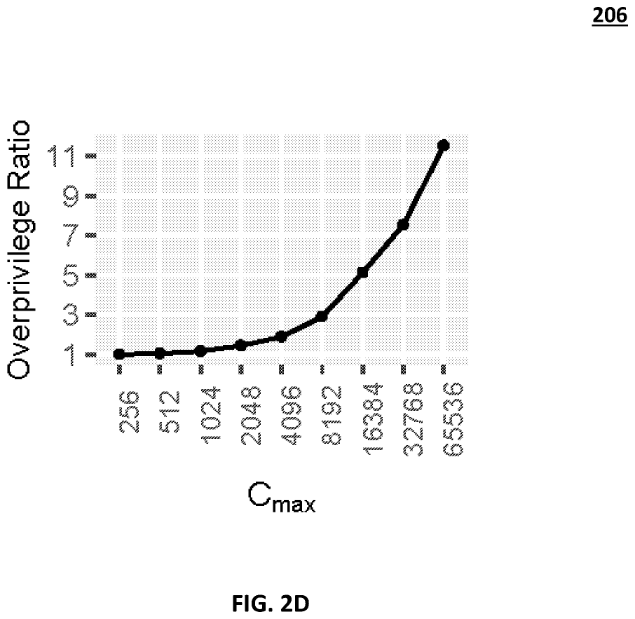

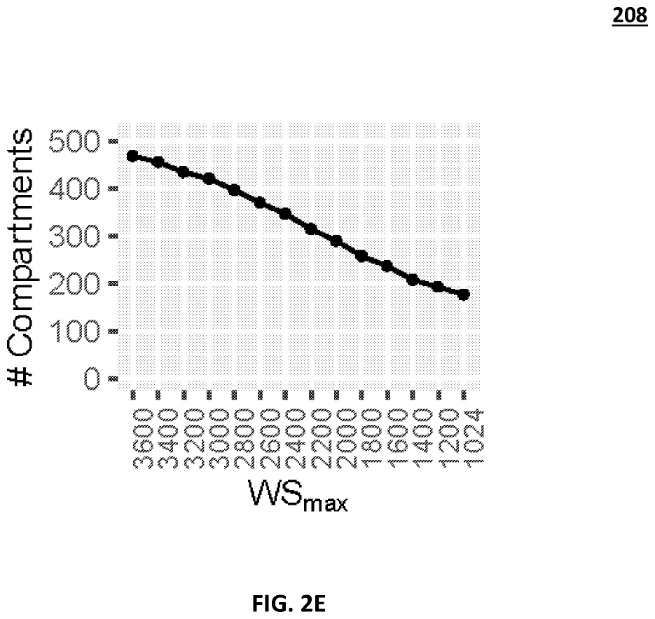

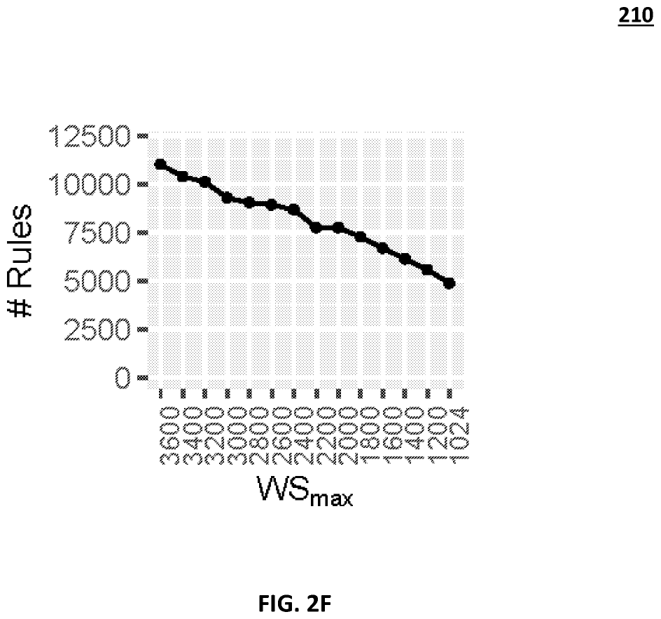

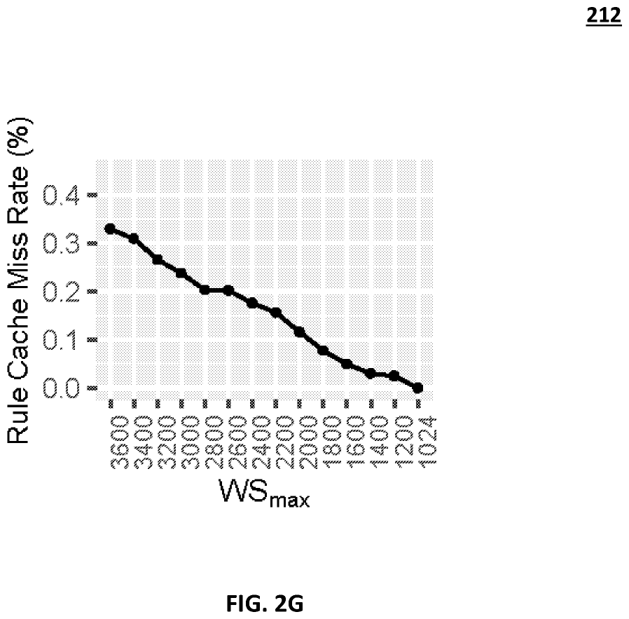

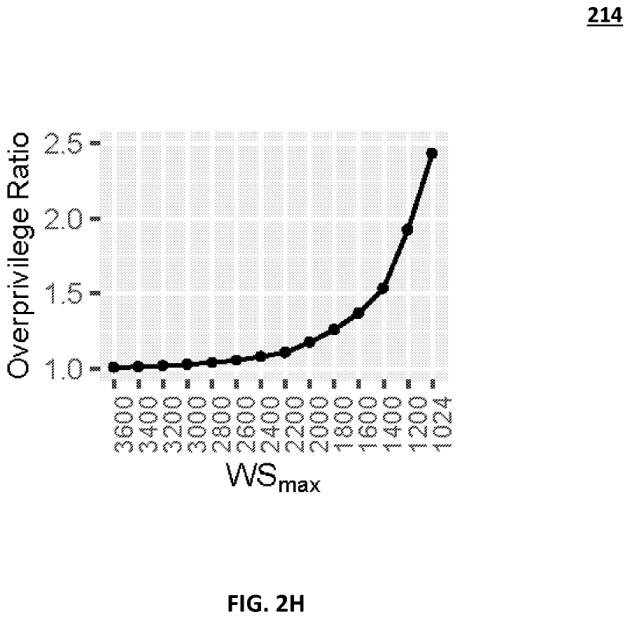

FIGS. 2A-H depict a set of graphs 200-214 indicating impact of clustering algorithms on an HTTP web server running on a 1024-entry rule cache. As depicted, graphs 200-206 represented by FIGS. 2A-D relate to the impact a Domain-Size algorithm and graphs 208-214 represented by FIGS. 2E-H relate to the impact of a Working-Set algorithm. In particular, FIG. 2A shows how the number of compartments trends with the Cₘₐₓ parameter on the HTTP web server application. As can be seen, the Domain-Size algorithm coupled with a target size parameter exposes a wide range of compartmentalization strategies, from just a few compartments up to hundreds. FIG. 2B shows the total number of rules that are required to represent the compartmentalization policy at that granularity. With fewer compartments there are fewer unique subject domains, object domains and interaction edges, which means fewer total rules are required for the design. FIG. 2C shows the dynamic runtime rule cache miss rate of the compartmentalization produced from that Cₘₐₓ value. FIG. 2D shows how the Overprivilege Ratio trends with target domain size. Similarly to FIGS. 2A-D, FIGS. 2E-H show how the number of compartments, rules, the rule cache miss rate, and the overprivilege ratio all trend with WSₘₐₓ parameter in the Working-Set algorithm. Note how the Working-Set algorithm outperforms the Domain-Size algorithm in terms of the number of compartments, rules, and overprivilege ratio for the same rule cache miss rate.

7.3 Working-Set Compartments

The Domain-Size compartment algorithm allows us to explore a wide range of compartmentalization strategies independent of the security architecture, but it is not particularly well-suited to the PIPE. The utility function that drives cluster merge operation is the number of dynamic calls and returns between those clusters. For enforcement mechanisms that impose a cost per domain transition (such as changing capabilities or changing page tables between processes when using virtual memory process isolation), such a utility function would be a reasonable choice, as it does lead to minimizing the number of cross-compartment interactions. Grouping together code and data in this way does reduce the number of tags, rules, and thus cache characteristics of enforcing the compartmentalization on the PIPE, but there is only a broad correlation (FIG. 2C).

For the PIPE, there is no cost to change domains, provided the required rules are already cached; instead, what matters is rule locality. As a result, to produce performant policies for the PIPE, we instead would like to optimize the runtime rule cache characteristics rather than minimizing the number of domain transitions. To this end, we construct an algorithm based on reducing the set of rules required by each of a program's phases so that each set will fit comfortably into the rule cache for favorable cache characteristics.

How do we identify program phases such that we can consider their cache characteristics? Recall that the tracing policy records the rules that it encounters during each epoch of 1M instructions (Section 5). We consider the set of rules encountered during each epoch to compose a working set. As an intuitive, first-order analysis, if we can keep the rules in each working set below the cache size and the product of those rules and the miss handling time small compared to the epoch length, the overhead for misses in the epoch will be small. As we will see, since not all rules are used with high frequency in an epoch, it isn't strictly necessary to reduce the rules in the epoch below the cache size. While there is prior work on program phase detection, SCALPEL takes a simple epoch-based approach that we see is adequate to generate useful working sets; integrating more sophisticated phase detection into SCALPEL would be interesting future work and would only improve the benefits of the PIPE protection policy.

An example of how the rule savings is calculated for merging the S₁ and S₂ domains together. In this example, there are five rules (privilege triples) in Working Set 1 before the merge, and three rules afterwards, for a total of two rules saved. However, S₂ did not have write access to O₁ before the merge, so overprivilege is also introduced by the merge. Assuming all components of the system have a uniform weight of one, then the utility for this merge would be two (two rules saved) and the cost would be one (one additional privilege exposed), for a ratio of 2/1=2. The Working-Set algorithm is driven by the ratio of rules saved in working sets to the increase in privilege, allowing it to enforce as much of the fine-grained access control privileges as possible for a given rule cache miss rate. Note that following the depicted subject merge, merging objects O₁ and O₂ would be chosen next by the algorithm, as it would save an additional rule at no further increase in privilege; in this way, the Working-Set algorithm simultaneously constructs both subject and object domains.

The Working-Set algorithm targets a maximum number of rules allowed per working set, WSₘₐₓ. We construct the Working-Set algorithm in a similar fashion to the Domain-Size algorithm (Section 7.2), except that we consider clustering of both subjects and objects simultaneously under a unified cost function. The algorithm works as follows: upon initialization, each function is placed into a subject domain Sᵢ and each primitive object is placed into a separate object domain Oᵢ. We then initialize the rules in each working set to those found by the tracing policy during that epoch. At each step of the algorithm, either a pair of subjects or a pair of objects are chosen for merging together. The pair that is chosen is the pair with the highest ratio of a utility function to that of a cost function across all pairs. In contrast to the Domain-Size algorithm, the utility function we use is the sum of the rules that would be saved across all working sets that are currently over the target rule limit WSₘₐₓ.

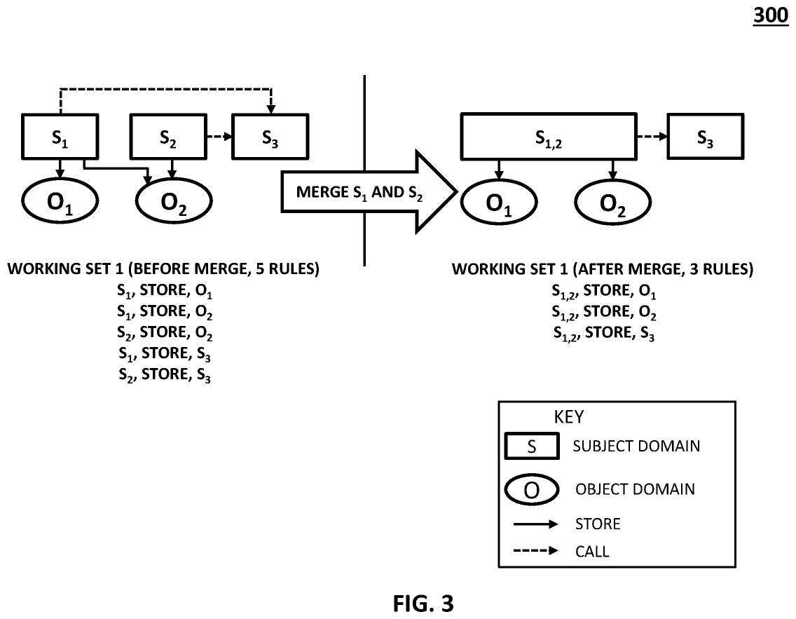

FIG. 3 depicts an example 300 of merging working set domains (e.g., S1 and S2) to reduce the number of rules, e.g., an example showing how the rule delta calculation is performed. In example 300, there are five rules (privilege triples) in Working Set S1 before the merge, and three rules afterwards, for a total of two rules saved. However, Working Set S2 did not have write access to O1 before the merge, so overprivilege is also introduced by the merge. Assuming all components of the system have a uniform weight of one, then the utility for this merge would be two (two rules saved) and the cost would be one (one additional privilege exposed), for a ratio of 2/1=2. The Working-Set algorithm is driven by the ratio of rules saved in working sets to the increase in privilege, allowing it to enforce as much of the fine-grained access control privileges as possible for a given rule cache miss rate. Note that following the depicted subject merge, merging objects O1 and O2 would be chosen next by the algorithm, as it would save an additional rule at no further increase in privilege; in this way, the Working-Set algorithm simultaneously constructs both subject and object domains.

After performing a merge, the new, smaller set of rules that would be required for each affected working set is calculated, and then the process repeats. The Working-Set algorithm uses the same cost function as the Domain-Size algorithm, i.e., the increase in privilege that would result from combining the two subjects or objects into a single domain. As a result, the Working-Set algorithm attempts to reduce the number of rules required by the program during each of its program phases down to a cache-friendly number while minimizing the overprivilege. The algorithm is run until the number of rules in all the working sets is driven below the target value of WSₘₐₓ.

TABLE 1
Architectural modeling parameters

| Model | Cost (cycles) |
|---|---|
| Cyc_{L1} (64 KB, 4-way) | 1 |
| Cyc_{L2} (512 KB, 8-way) | 3 |
| Cyc_{DRAM} (2 GB) | 100 |
| Cyc_{policy}_{_{—}}ₑᵥₐₗ | 300 |
| Cyc_{PIPE} (DMHC, 1024) | 1 |

Like the Domain-Size algorithm, we can vary the value of WSₘₐₓ to produce a range of compartmentalizations at various privilege-performance tradeoffs. If we set our WSₘₐₓ target to match the actual rule cache size, we will pack the policy down to fit comfortably in the cache and produce a highly performant policy; on the other hand, we find that this tight restriction isn't strictly necessary—FIG. 2G shows how the rule cache miss rate trends with the target WSₘₐₓ value, achieving an almost linear reduction in miss rate with WSₘₐₓ.

The core advantage of the Working-Set algorithm is that it is able to coarsen a compartmentalization in only the key places where it actually improves the runtime cache characteristics of the application, while maintaining the majority of fine-grained rules that don't actually contribute meaningfully to the rule cache pressure. In FIGS. 2E-H, we show how the number of compartments, the number of rules, the rule cache miss rate, and the overprivilege ratio trend with the WSₘₐₓ parameter. In contrast to the Domain-Size algorithm, we can see that many more compartments and rules are maintained as the algorithms are driven to smaller and smaller rule cache miss rates, demonstrating the advantages of the Working-Set algorithm in intelligently producing compartmentalization policies at much lower levels of overprivilege. For example, at the WSₘₐₓ of 1024 the Working-Set algorithm achieves the same rule cache miss rate as the Domain-Size algorithm does at a Cₘₐₓ of 16,364, but it has more than twice as many total rules and an Overprivilege Ratio that is twice as small, a much more privilege-restricted design for the same overhead. We illustrate the differences between the algorithms more directly in Section 9 (Evaluation).

### 8. Performance Model

Our SCALPEL evaluation targets a single-core, in-order RISC-V CPU that is extended with the PIPE tag-based hardware security monitor. To match a typical, lightweight embedded processor, we assume 64 KB L1 data and instruction caches and a unified 512 KB L2 cache.

To this we add a 1,024 entry DMHC PIPE rule cache. The application is a single, statically-linked program image that includes both the FreeRTOS operating system as well as the program code. The image is run on a modified QEMU that simulates data and rule caches inline with the program execution to collect event statistics. SCALPEL is built on top of an open-source PIPE framework that includes tooling for creating and running tag policies. The architectural modeling parameters we use are given in Table 1. We use the following model for baseline execution time:

T_{baseline}=Nᵢₙₛₜ+N_{L1I}_{ₘᵢₛₛ}×Cyc_{L2}+N_{L1D}_{ₘᵢₛₛ}×Cyc_{L2}+N_{L2}_{ₘᵢₛₛ}×CYC_{DRAM}

Beyond the baseline, SCALPEL policies add overhead time to process misses:

T_{SCALPEL}=T_{baseline}+N_{PIPE}_{ₘᵢₛₛ}×Cyc_{policy_eval}

We take Cyc_{policy_eval} to be 300 cycles based on calibration measurements from our hash lookup implementation.

Lastly, we calculate overhead as:

$$Overhead = \frac{{T}_{S C A L P E L} - {T}_{b a s e l i n e}}{{T}_{b a s e l i n e}} \times 100 \%$$

### 9. Evaluation and Results

In this section we present the results of our SCALPEL evaluation. Section 9.1 details the applications we use to conduct our experiments. Section 9.2 shows statistics about the applications and the results of the tracing policy. Section 9.3 shows the privilege-performance results of SCALPEL's Domain-Size and Working-Set algorithms. Section 9.4 shows the Syntactic Domains and the results of applying the syntactic constraints to the Working-Set algorithm. Lastly, Section 9.5 shows how SCALPEL's Working-Set rule clustering technique can be used to pack entire policies for real-time systems.

9.1 Applications

HTTP Webserver: One application we use to demonstrate SCALPEL is an HTTP web server built around the FreeRTOS+FAT+TCP demo application. Web servers are common portals for interacting with embedded/IoT devices, such as viewing baby monitors or configuring routers. Our final system includes a TCP networking stack, a FAT file system, an HTTP web server implementation, and a set of CGI programs that compose a simple hospital management system. The management system allows users to login as patients or doctors, view their dashboard, update their user information, and perform various operations such as searches, prescribing medications, and checking prescription statuses. All parts of the system are written in C and are compiled together into a single program image. To drive the web server in our experiments, we use curl to generate web requests. The driver program logs in as a privileged or unprivileged user, performs random actions available from the system as described above, and then logs out. For the tracing policy, we run the web server for 500 web requests with a 0.25 s delay between requests, which we observe is sufficient to cover the web server's behavior. For performance evaluation, we run five trials of 100 requests each and take the average.

libXML Parsing Library: Additionally, we port the libXML2 parsing library to our FreeRTOS stack. To drive the library, we construct a simple wrapper around the xmlTextReader SAX interface which parses plain XML files into internal XML data structures. For our evaluation experiments, we run it on the MONDIAL XML database, which contains aggregated demographic and geographic information. It is 1 MB in size and contains 22 k elements and 47 k attributes. Parsing structured data is both common in many applications and is also known to be error-prone and a common source of security vulnerabilities: libXML2 has had 65 CVEs including 36 memory errors between 2003 and 2018. Our libXML2 is based on version 2.6.30. Timing-dependent context switches causes nondeterministic behavior; we run the workload five times and take the average.

H264 Video Encoder, bzip2, GNU Go: Additionally, we port three applications from the SPEC benchmarks that have minimal POSIX dependencies (e.g., processes or filesystems) to our FreeRTOS stack. Porting the benchmarks involved translating the main function to a FreeRTOS task, removing their reliance on configuration files by hardcoding their execution settings, and integrating them with the FreeRTOS dynamic memory allocator. The H264 Video Encoder is based on 464.h264ref, the bzip2 compression workload is based on 401.bzip2, and the GNU Go implementation is based on 445.gobmk. Video encoders are typical for any systems with cameras (baby monitors, smart doorbells) compression and decompression are common for data transmission, and search implementations may be found in simple games or navigation devices. We run the H264 encoder on the reference SSS.yuv, a video with 171 frames with a resolution of 512×320 pixels. We run bzip2 on the reference HTML input and the reference blocking factors. We run GNU Go in benchmarking mode, where it plays both black and white, on an 11×11 board with four random initial stones. Timing-dependent context switches causes nondeterministic behavior; we run each workload five times and take the average.

9.2 Application Statistics and the Tracing Policy

TABLE 2
Application statistics and results of the tracing policy

| | Lines of | Live Functions/ | Total | Monolithic |
|---|---|---|---|---|
| Application | Code | Live Objects | Rules | OR |
| bzip2 | 8k | 128/109 | 2,880 | 39 |
| HTTP web server | 49k | 1,231/218 | 12,025 | 96 |
| H264 | 53k | 363/692 | 19,641 | 244 |
| GNU Go | 198k | 3,288/10,532 | 30,077 | 187 |
| libXML | 290k | 260/384 | 10,221 | 538 |

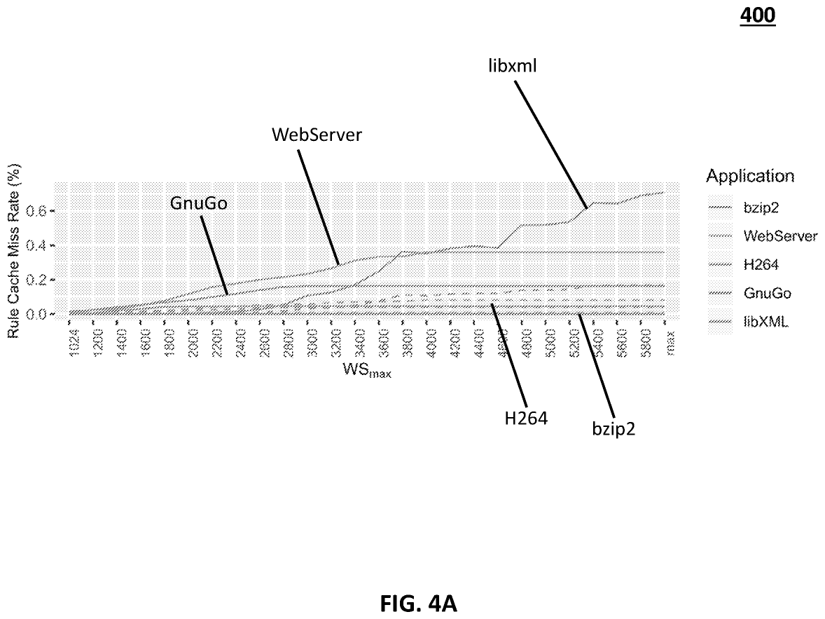

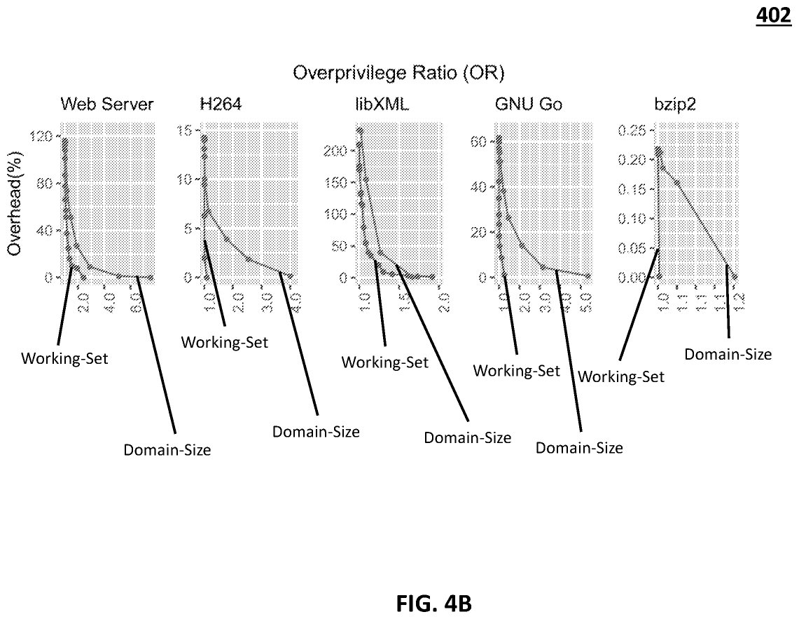

In Table 2, we show application statistics and the results of the tracing policy. First, to give a broad sense for the application sizes, we show the total lines of code; this column includes only the application, on top of which there is an additional 12 k lines of core FreeRTOS code. Next, we show the total number of live functions and objects logged by the tracing policy during the program's execution. These subjects and objects compose the fine-grained privileges that SCALPEL enforces. In the Total Rules column, we show the total number of unique rules generated during the entire execution of the program under the tracing policy granularity (Section 5). While this number indicates the complexity of the program's data and control graph, it is not necessarily predictive of the cache hit rate, which depends on the dynamic rule locality. We show the rule cache miss rate in FIG. 4A: The rightmost point (max) corresponds to the miss rate at the tracing policy granularity. As can be seen, the web server has fewer rules than libXML, but also has a lower cache hit rate due to the larger amount of logic that runs at its steady-state web serving phases (such as receiving network requests, parsing them, running CGI programs, and sending output). In contrast, H264 has more total rules, but exhibits more locality as it spends long program phases on a small subset of code and data (e.g., doing motion estimation), a much more rule-cache-friendly workload. Very simple workloads, such as bzip2, require only a couple thousand rules and have effectively no rule cache misses even at the tracing-level granularity.

FIG. 4A is a diagram 400 illustrating impact of the WSₘₐₓ parameter on a rule cache miss rate for a 1,024-entry rule cache. As shown in FIG. 4A, the max value corresponds to the tracing-level granularity (Table 2), and the solid lines show how the rule cache miss rate trends with WSₘₐₓ. As indicated in FIG. 4A, the SCALPEL algorithms allow a designer to generate compartmentalization designs that target any desired rule cache miss rate. The dashed lines show the even lower rule cache miss rate that is achieved by prefetching rules, which we describe in Section 10.

9.3 Privilege-Performance Tradeoffs

A key question we would like to answer is how we can trade off privilege for performance on a per-application basis using the range of SCALPEL compartment generation algorithms (Section 7). As depicted, FIG. 4A shows how the rule cache miss rate trends with the WSₘₐₓ parameter to the Working-set algorithm: As can be seen, it allows a designer to target any desired rule cache miss rate for an application.

FIG. 4B depicts privilege-performance plots 402 for five different applications generated from both the Domain-Size algorithm and the Working-Set algorithm. As shown, FIG. 4B depicts a range of compartmentalizations produced from SCALPEL's algorithms on a 1024-entry rule cache. Each point corresponds to a single specific concrete compartmentalization that is run for performance evaluation and characterized by its runtime overhead (Y axis) and aggregate Overprivilege Ratio (X axis). The Domain-size line shows compartments that are generated from the various values of Cₘₐₓ to the Domain-size algorithm, and the Working-set line shows compartments that are generated from the various values of WSₘₐₓ to the Working-set algorithm. As can be seen, SCALPEL allows a security engineer to rapidly create and evaluate many compartmentalization strategies to explore design tradeoffs without the excessive labor required for manual separations. It should be noted that the Working-set algorithm dominates the Domain-size algorithm, with a particularly strong advantage at the low-end of the overhead spectrum.

To explore these compartmentalization options, in FIG. 4B, we show the privilege-performance curves (where each compartmentalization design is scored by its overhead and Overprivilege Ratio) generated from both the Domain-size algorithm and the Working-set algorithms. The Domain-Size lines in plots 402 correspond to the range of compartmentalizations produced from the Domain-Size algorithm and its Cₘₐₓ parameter. Referring to a Domain-Size algorithm line of a given plot, the top-left point in the Domain-Size algorithm corresponds to the tracing-level granularity; this point enforces the full, fine-grained access control matrix, but also imposes large overheads; for example, on the webserver application, the cost of enforcement is >100%. The other points in this line correspond to larger values of the Cₘₐₓ parameter, which produces fewer, larger compartments for more favorable runtime overheads; however, as can be seen, these coarser compartmentalizations also introduce additional overprivilege.

The Working-Set lines in plots 402 correspond to the range of compartmentalizations produced from the Working-Set algorithm and its WSₘₐₓ parameter. Referring to a Working-Set line of a given plot, the top-left point corresponds to the maximum value of WSₘₐₓ where no clustering is performed. The bottom-right point corresponds to packing the rules in each working set to the rule cache size (1,024), producing designs that have very favorable performance characteristics but more overprivilege.

Note that in both cases the curves have a very steep downward slope, meaning large improvements in runtime performance can be attained with little increases in privilege; the curves eventually flatten out, at which point additional decreases in overhead come at the expense of larger amounts of overprivilege. Note that the Working-Set compartments strictly dominate the Domain-Size compartments, producing more privilege reduction at lower costs than the Domain-Size counterparts. As can be seen, SCALPEL allows designers to easily explore the tradeoffs in compartmentalization tag policies. These runs represent the default, fully-automatic tool flow. A designer can then easily inspect the produced compartmentalization files, tune the privilege weights, and rerun the tools interactively as time and expertise allow.

9.4 Syntactic Compartments and Syntactic Constraints

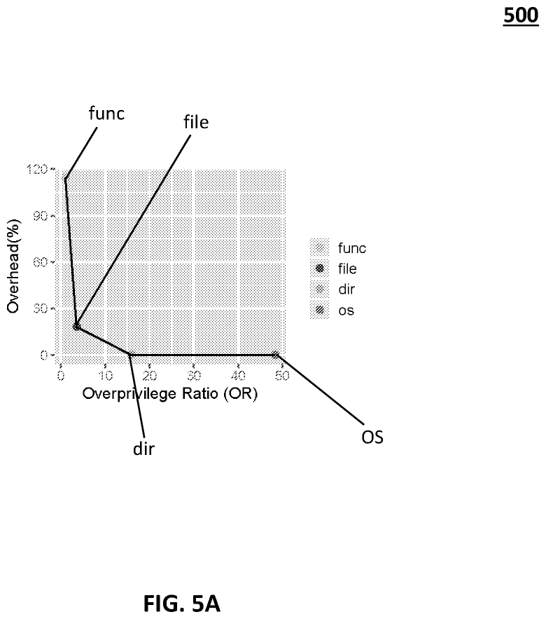

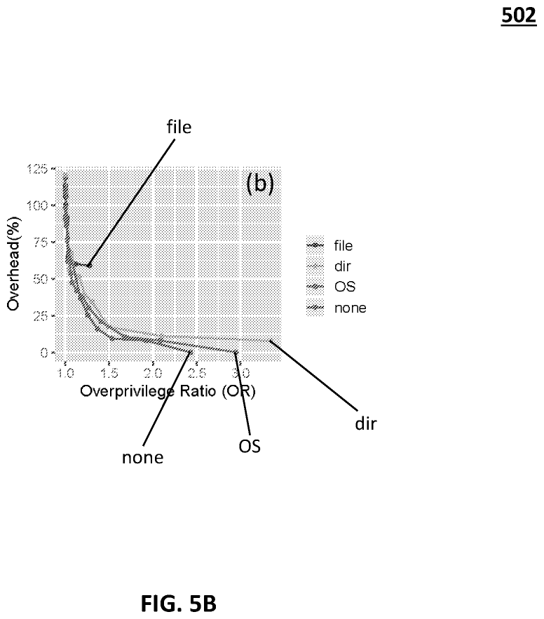

FIGS. 5A-B depict privilege-performance plots 500-502 indicating impact of Syntactic Domains and Constraints on an HTTP web server running on a 1024-entry rule cache. In FIG. 5A, we show the syntactic compartments (Section 7.1) on the HTTP web server application. Unlike the Domain-Size and Working-Set algorithms, which are parameterized to produce a wide range of compartmentalization options, the syntactic compartments only provide a handful of decomposition choices. And, as can be seen, none of the options are competitive compared to the Domain-Size of Working-Set decompositions, which suggests that it is indeed useful to approach the compartmentalization problem with more sophisticated techniques.

However, it is also true that software engineers often decompose their own projects into modules, and those modules boundaries bear semantic information about code interfaces and relationships. For example, the webserver application has the core FreeRTOS code in one directory, the TCP/IP networking stack in another directory, the webserver application (CGI app) in another directory, and the FAT filesystem implementation in another separate directory. When the algorithmic compartment generation algorithms (Sections 7.2, 7.3) optimize for privilege-performance design points, they have the full freedom to reconstruct boundaries in whatever way they find produces better privilege-performance tradeoffs. However, if we would like to preserve the original syntactic boundaries during the algorithmic optimization process, we can add additional constraints, such as a syntactic constraint, which limits the set of legal merges allowed by the algorithms. For example, under the file syntactic constraint, two global variables can only be merged if they originate from the same source file. This allows SCALPEL to optimize privilege separation internal to a module while respecting the interfaces to that module. We note that a compartmentalization that is a strict sub-decomposition of another compartmentalization is never less secure.

In FIG. 5B, we show the application of the syntactic domains as constraints to the Working-Set algorithm. The OS restriction adds little additional overhead to the produced design points but guarantees a cleaner separation of the OS and application than may be found by the algorithms naturally. However, the file constraint is very restrictive, reducing the number of moves available to the algorithms to such a large extent that many of the WSₘₐₓ targets fail to generate. These examples illustrate the benefits of the rapid exploration enabled by SCALPEL, and we note that a manually-constructed constraint can be a very convenient method for interacting with SCALPEL's automation.

9.5 Packing Policies for Real-Time Systems

Various ideas presented in the Working-Set algorithm (Section 7.3) can be used to pack an entire security policy (e.g., the complete set of rules that compose the policy) into a single, fixed-size set of rules. For this construction, we may take the union of all rules required to represent the policy and present it to the Working-Set algorithm as a single working set—the entire policy will then be packed down to a number of rules equal to WSₘₐₓ. Importantly, this means that the policy can be loaded in a constant amount of time, and assuming the WSₘₐₓ matches the rule cache size, then no additional runtime rule resolutions will occur, giving the system predictable runtime characteristics suitable for real-time systems. We show the results of this technique in Table 3 when applied to a range of rule targets.

Table 3 shows the OR of various applications when they are packed for real-time performance to the given total rule count (e.g., as allowed by a rule cache's capacity). When packed in this way, they can be (1) loaded in constant time and (2) experience no additional runtime rule resolutions, making them suitable for real-time systems.

TABLE 3
OR of packed applications

| | Real-Time Rule Target | | | | |
|---|---|---|---|---|---|
| Application | 512 | 1024 | 2048 | 4096 | 8192 |
| bzip2 | 2.82 | 1.34 | 1.01 | 1.00 | 1.000 |
| Web Server | 8.92 | 5.76 | 2.71 | 1.35 | 1.005 |
| H264 | 11.9 | 2.81 | 1.46 | 1.05 | 1.002 |
| libXML | 12.3 | 7.46 | 2.61 | 1.18 | 1.000 |
| Gnu Go | 29.4 | 12.7 | 3.47 | 1.43 | 1.033 |

The overprivilege points generated from this technique could be used to decide on a particular rule cache size for a specific embedded application to achieve target protection and performance characteristics. Note that the working-set cached case achieves lower OR at a same 1024-entry rule capacity since it only needs to load one Working-Set at a time. It will take a larger rule cache to achieve comparably low OR. However, it is worth noting that, if the rule memory does not need to act as a cache, it can be constructed more cheaply than a dynamically managed cache, meaning the actual area cost is lower than the ratio of rules, and might even favor the fixed-size rule memory. Furthermore, if one is targeting a particular application, the tag bits can also be reduced to match the final compartment and object count (e.g., can be 8 bits instead of a full word width), which will further decrease the per rule area cost.

### 10. Prefetching

Further, we consider another performance optimization to reduce the overhead costs of SCALPEL's policies: rule prefetching. During the normal operation of the PIPE, rules are evaluated and installed into the rule cache only when an application misses on that rule. When such a miss occurs, the PEX core awakens, evaluates the rule, and finally installs it into the rule cache. Much like prefetching instructions or data blocks for processor caches, there is an opportunity for the PEX core to preemptively predict and install rules into the cache. Such a technique can greatly reduce the number of runtime misses that occur, provided that the required rules can reliably be predicted and prefetched before they are needed. In this section we explore the design and results of a rule prefetching system.

10.1 The Rule-Successor Graph

The core data structure of our prefetching design is the Rule-Successor Graph. The Rule-Successor Graph is a directed, weighted graph that records the immediate temporal relationships of rule evaluations. A rule is represented as a node in the graph, and a weighted edge between two nodes indicates the relative frequency of the miss handler evaluating the source rule followed immediately by evaluating the destination rule.

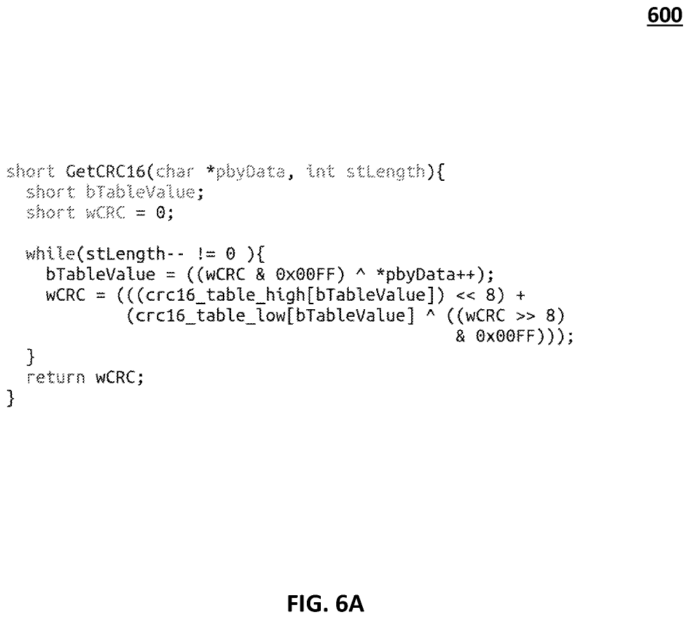

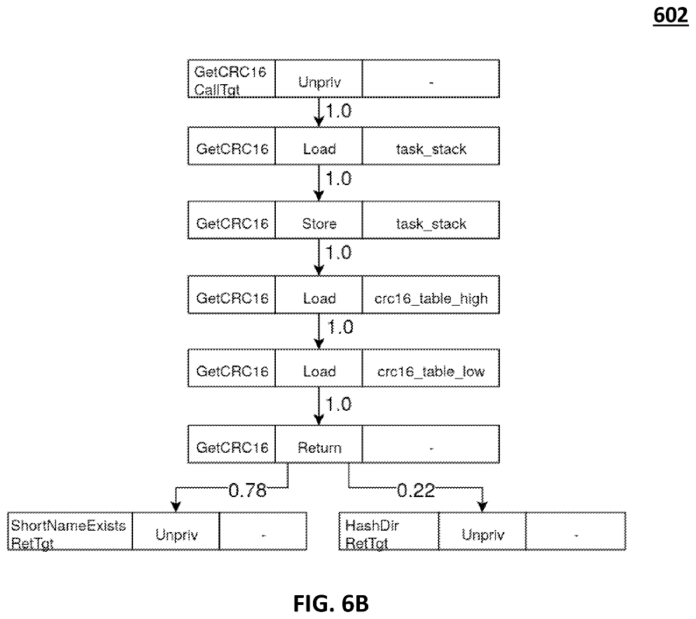

FIGS. 6A-B show an example function and a corresponding Rule-Successor Graph usable in prefetching decisions. In particular, FIG. 6A shows an example function from the FreeRTOS FAT filesystem, and FIG. 6B shows the Rule-Successor Graph for its function-entry rule. Each rule (privilege triple) is shown as a rectangle with three fields corresponding to the subject, operation and object tags. When this function is called, it issues loads and stores to the task's stack, and then it issues loads to the crc16_table_high and crc16_table_low global variables in exactly that order; this deterministic sequence is learned and encoded in the Rule-Successor Graph. Many kinds of rule relationships are highly predictable, such as rules that are required for sequential instructions in the same basic block.

However, data or control-flow dependent program behavior can produce less predictable rule sequences—for example, a return instruction can have many, low-weighted rule successors if that function is called from many locations within a program. In this example, GetCRC16 has two callers and may return to either, although one is much more common than the other; similarly, GetCRC16 also accepts a data pointer pbyData that could produce data-dependent rule sequences depending on the object it points to, although in this program it always points to the task's stack, which does not require another rule. Lastly, if stLength were 0, then the program would take an alternate control-flow path and several of the rules would be skipped. Like other architectural optimizations such as caches and branch predictors, optimistic prefetching accelerates common-case behavior, but may have a negative impact on performance when the prediction in wrong.

A program's Rule-Successor Graph can be generated from the miss handler software with no other changes to the system. To do so, the miss handler software maintains an account of the last rule that it handled. When a new miss occurs, the miss handler software updates the Rule-Successor Graph by updating the weight from the last rule to the current rule (and adding any missing nodes, if any). Finally, the record of which rule was the last rule is updated to the current rule, and the process continues.

10.2 Generating Prefetching Policies

A prefetching policy is a mapping from each individual rule (called the source rule) to a list of rules (the prefetch rules) that are to be prefetched by the miss handler when a miss occurs on that source rule. Prefetching policies are generated offline using a program's Rule-Successor Graph; the goal is to determine which rules (if any) should be prefetched from each source rule on future runs of that program.

To find good candidate prefetch rules for each source rule, we deploy a Breadth-First Search algorithm on the Rule-Successor Graph to discover high likelihood, subsequent rules. Each such search begins on a source rule with an initial probability p=1.0. When a new node (rule) is explored by the search algorithm, its relative probability is calculated by multiplying the current probability by the weight of the edge taken. When a new, unexplored rule is discovered, it is added to a table of explored nodes, and its depth and probability are recorded with it. If a rule is already in the table when it is explored from a different path, then the running probability is added to the value in the table to reflect the sum of the probabilities of the various paths on which the rule may be found.

The algorithm terminates searching on any path in which the probability falls below a minimum threshold value. We set this value to 0.1%, which we observe sufficiently captures the important rules across our benchmarks. After search is complete, the table of explored nodes is populated and ready to be used for deriving prefetching policies. To test the impact of various degrees of prefetching, we add a pruning pass in which any rules below a target probability pₘᵢₙ are discarded from the table. For example, if pₘᵢₙ is set to the maximum of 1.0, then rules are only included in the prefetching set if they are always observed to occur in the Rule-Successor Graph following the source rule. On the other hand, if pₘᵢₙ is set to 0.5, then more speculative rules will be considered. These may run a higher risk of both not averting future misses, and in the worst-case may pollute the rule cache by evicting a potentially more-important rule. In FIG. 6B, the bottom left rule has a probability of 0.78—it will be included in the prefetch rules along the five above it only if pₘᵢₙ is at least 0.78. If no rules remain after pruning, then no prefetch rules are found. Otherwise, the remaining rules are sorted to compose the final list of prefetch rules. They are sorted by depth (smallest first), then within the same depth by probability (highest first) to order the rules in a sequence most likely to be useful. We enforce a maximum limit of fifteen prefetch rules per source rule. We vary the values of pₘᵢₙ from 1.0 to 0.25 to explore the impact of various levels of prefetching on final performance.

10.3 Prefetching Cost Model

When the PIPE misses on a rule, it traps and alerts the PEX core for rule evaluation. In SCALPEL, a rule evaluation is a hash table lookup that checks the current operation against a privilege table (Section 4). When prefetching is enabled, we choose to store the prefetch rules in the privilege hash table along with the source rule to which they belong. When a miss occurs, the miss handler performs the initial privilege lookup on the source rule and installs it into the PIPE cache, allowing the AP core to resume processing. Afterwards, the PEX core continues to asynchronously load and install the rest of the prefetch rules in that hash table entry. Assuming a cache line size of 64B and a rule size of 28B (five 4B input tags and two 4B output tags), then two rules fit in a single cache line. As such, the first prefetch rule can be prepared for insertion immediately following the resolution of the source rule. We assume a 10 cycle install time into the PIPE cache for each rule installation. For each subsequent cache line (which can hold up to two rules), we add an additional cost of 20 cycles for a DRAM CAS operation, in addition to the 10 cycle insertion time for each rule. We set the maximum number of prefetch rules to seven so that all eight rules (including the source rule) may fit onto a single same DRAM page, assuming a 2048b page size.

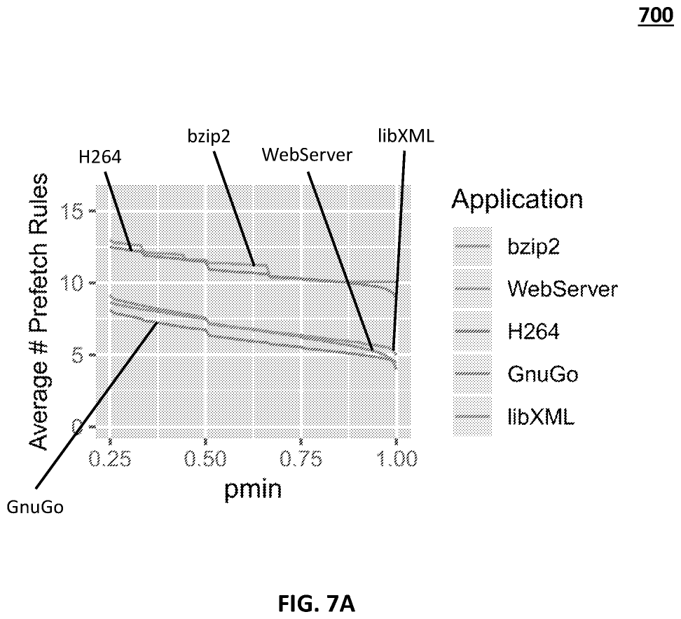

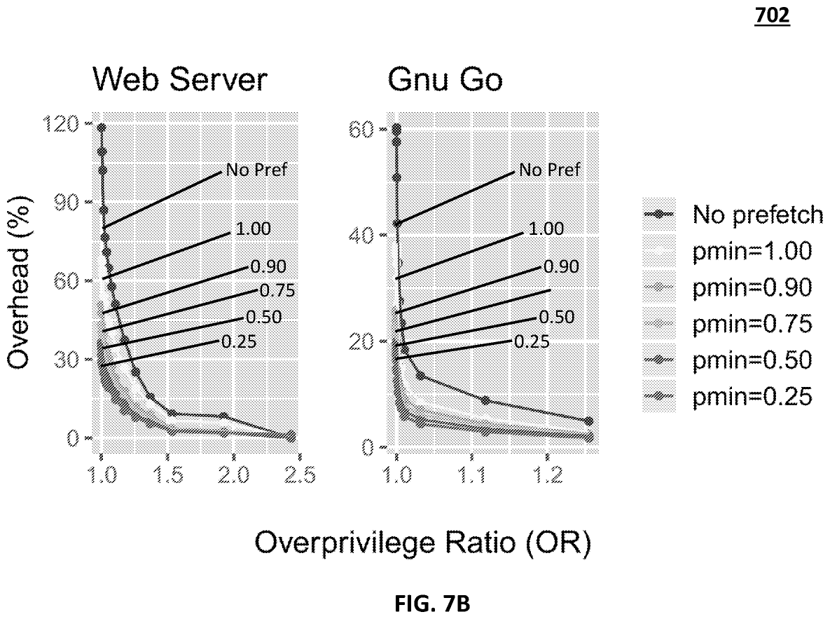

We begin by looking at FIG. 7A. FIG. 7A depicts a Rule-Successor structure graph 700 for various applications and indicates how much prefetching is possible based on the minimum probability of a prefetched rule being used. Graph 700 provides an indication that the number and likelihood of prefetch rules per source rule that might be prefetched; the more high-likelihood rules there are, the more benefits we expect to see from prefetching. In graph 700, the X axis shows the pₘᵢₙ cutoff probability in the range of [0.25,1], and the Y axis shows the average number of rules per source rule that have at least the given cutoff probability. The data shows that there around five rules per source rule that can be prefetched even at the maximum pₘᵢₙ value of 1.0 (i.e., they always follow the source rule during tracing); H264 and bzip2 are more predictable than the other three benchmarks with values closer to ten. At lower values of pₘᵢₙ, more rules make the cutoff, although the slope is low (less than one rule on average per 10% decrease in likelihood) meaning there are significantly diminishing returns on prefetching larger numbers of rules.

Next, to see results of prefetching on rule cache miss rate, prefetching cases are shown as dashed lines in FIG. 7B. To see a final impact on program overhead, FIG. 7B depicts privilege-performance plots 702 indicating impact of prefetching policies on OR for two applications (e.g., privilege-performance curves generated from the various prefetching policies). The “no prefetch” line shows the baseline (no prefetching) case, and the other lines show the prefetching policies generated from the various values of pₘᵢₙ. All of the prefetching cases strictly dominate the baseline case on privilege and performance; the yellow line (pₘᵢₙ=1.0) captures a majority of the benefits, but each additional relaxation to pₘᵢₙ continues to lower enforcement costs for the same privilege reduction level in diminishing amounts. On the high end of the overhead spectrum (e.g., the tracing-level granularity), the prefetching system reduces the overhead from an average of 105% to only 27%, a 3.9× reduction in enforcement costs. This shows the predictable nature of PIPE rules in a compartmentalization policy and the large benefit of prefetching rules to reduce costs. On the lower end of the overhead spectrum, the benefits of prefetching are less pronounced but do enable the system to achieve even finer privilege separation at the same costs. At an overhead of 10%, the prefetching cases allow for 20% more total rules and an OR that is 12% smaller.

### 11. Security, Overprivilege, and Work-Factor

Vulnerabilities, such as memory safety errors, permit a program to perform behaviors that violate its original language-level abstractions, e.g., they allow a program to perform an access to a memory location that is either outside the object from which the pointer is derived or has since been freed and is therefore temporally expired. An exploit developer has the task of using such a vulnerability to corrupt the state of the machine and to redirect the operations of the new, emergent program such as to reach new states that violate underlying security boundaries or assumptions, such as changing an authorization level, leaking private data, or performing system calls with attacker-controlled inputs. In practice, bugs come in a wide range of expressive power, and even memory corruption vulnerabilities are often constrained in one or more dimensions, e.g., a typical contiguous overflow error may only write past the end of an existing buffer, or an off-by-one error allows an attacker to write a pointer value past the end of an array but gives the attacker no control of the written data. Modern exploits are typically built from exploit chains, in which a series of bugs are assembled together to achieve arbitrary code execution, and complex exploits can take many man-months of effort to engineer even in the monolithic environments in which they run.

The privilege separation defenses imposed by SCALPEL limit the reachability of memory accesses and control-flow instructions to a small subset of the full machine's state. These restrictions affect the attacker's calculus in two ways: First, they may lower the impact of bugs sufficiently to disarm them entirely, i.e., rendering them unable to impart meaningful divergence from the original program. Second, they may vastly increase the number of exploitation steps and bugs required to reach a particular target from a given vulnerability: An attacker must now perform repeated confused deputy attacks at each stage to incrementally reach a target; when privilege reduction is high, these available operations become substantially limited, thus driving up attacker costs and defeating attack paths for which no exploit can be generated due to the imposed privilege separation limitations.

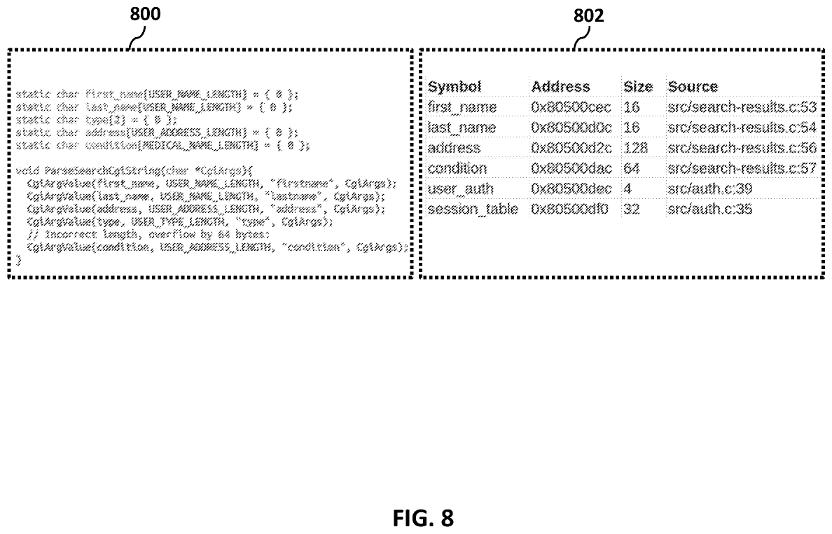

We illustrate these ideas with a vulnerability example from a web server application in FIG. 8. In particular, FIG. 8 shows search CGI code 800 with a vulnerability usable to corrupt user_auth and session_table values and triggerable by any user that browses to the search.html and also shows a symbol table 802 depicting addresses, sizes, and sources of various symbols in the web server's data section (e.g., user_auth and session_table values and static variables in code 800). For example, a buffer overflow in search CGI code 800 is reachable from a web server's web interface and can cause the program to write beyond the end of the condition buffer onto objects located at higher addresses, which are the user_auth and session_table variables. Corrupting user_auth can allow an unprivileged user to escalate their privileges. However, the fault is entirely contained if user_auth is tagged with an Object-ID for which CgiArgValue does not have write permission, because any out-of-bounds write will incur a policy violation.

TABLE 4
Relationship between WSₘₐₓ, Overprivilege Ratio, and Exploitability of a
Vulnerability in a Web Server

| WSₘₐₓ | max | 3200 | 2800 | 2400 | 2000 | 1800 | 1600 | 1400 | 1200 | 1024 | 512 |
|---|---|---|---|---|---|---|---|---|---|---|---|
| OR | 1.00 | 1.02 | 1.04 | 1.08 | 1.17 | 1.26 | 5.76 | 2.71 | 1.35 | 2.43 | 8.42 |
| Protect | ✓ | ✓ | ✓ | ✓ | ✓ | ✓ | ✓ | ✓ | X | X | X |
| user_ | | | | | | | | | | | |
| auth | | | | | | | | | | | |
| Protect | ✓ | ✓ | ✓ | ✓ | ✓ | ✓ | ✓ | ✓ | ✓ | X | X |
| session_ | | | | | | | | | | | |
| table | | | | | | | | | | | |
| Hash | 1 | 1 | 1 | 1 | 7 | 7 | 11 | 12 | 17 | 67 | 241 |
| Table | | | | | | | | | | | |
| equal | | | | | | | | | | | |
| call | | | | | | | | | | | |
| targets | | | | | | | | | | | |

In Table 4, we show the range of compartmentalizations generated from the Working-Set algorithm. Row 1 shows the compartmentalization's Overprivilege Ratio, and row 2 shows whether the user_auth overwrite is prevented (which we verify against our policy implementation by triggering the buffer overflow to classify as/or X in the table). If that write is not prevented, then an attacker can (1) escalate their privileges, and (2) there is also a possibility to corrupt the subsequent session_table as well if that object is also writable from CgiArgValue. The session_table is a structure that contains a hash table root node, which includes a code pointer session_table->compare. Like the user_auth object, this object is protected if the CgiArgValue code does not have permission to write to it. We show this relationship in row 3. If it can be corrupted, then it could provide additional footing to compromise the contained compartment, such as through hijacking the program's control flow by overwriting the session_table->compare field.

While we have illustrated that these specific vulnerabilities are eliminated at specific higher compartmentalization levels and lower ORs, we expect this trend to hold for other vulnerabilities—as OR lowers, at some point each specific vulnerability based on a privilege violation is eliminated. Each vulnerability may, in general, be eliminated at a different OR. Consequently, we expect lower OR to generally correlate well with lower vulnerability. Last, in row 4, we show the total number of legal call targets that are permitted by the domain containing HashTableEqual (the only function in the program that performs indirect calls using session_table->compare) to show the reachability of such a control-flow hijack. What this shows is that even if the code pointer is corrupted, the attacker is limited to only a handful of options to continue their attack, which for many of our domains is around 10 or less; furthermore, even those targets are all functions related to the hash table operations, which would require further steps still to reach other parts of the system. In other words, both examples show there is a relationship between the overprivilege permitted to each component of a system and the effort expended by exploit developers to weaponize their bugs to reach their targets.

### 12. Comparisons with Related Embedded System Security Work

Hex-Five's MultiZone Security is a state-of-the-art compartmentalization framework for RISC-V. However, it requires a developer to manually decompose the application into separated binaries called “zones”, each of which are very coarse grained—the recommended decomposition is one zone for FreeRTOS, one for the networking stack, and one or several for the application. MultiZone Security requires hundreds of cycles to switch contexts, which is negligible when only employed at millisecond intervals, but the overprivilege is very high, as large software components still have no separation; as a result, MultiZone Security achieves a privilege reduction that falls in between the OS and dir syntactic points shown in FIG. 5A. SCALPEL imposes significantly finer grained separation and provides substantially easier policy development and exploration. MINION is another compartmentalization tool for embedded systems. However, it also enforces only very coarse-grained separation by switching between a small number of memory views and provides no method for exploring policies to tune protection and performance characteristics.

ACES is closer to SCALPEL in terms of providing automatic separation for applications, however it targets enforcement using the handful of segments provided by the MPU. ACES has negligible overhead for some applications, but 20-30% overhead is more typical, with some applications requiring over 100% overhead. As a close comparison point, we run the Domain-Size algorithm with a few modifications to target four code and four object domains; the resulting design for the HTTP web server application has an OR of 28.7 compared to SCALPEL's OR of 1.28 (at a WSₘₐₓ of 1800 for a comparable overhead), which is more than 20× more separation at that level. As a result, SCALPEL shows that a hardware tag-based security monitor can be used to provide unprecedented levels of privilege separation for embedded systems.

### 13. Runtime Modes and Dynamic Analysis

13.1 Runtime Modes

In one example implementation, SCALPEL has two primary runtime modes: alert mode and enforcement mode. In alert mode, SCALPEL does not terminate a program if a policy violation is encountered; instead, it produces a detailed log of the privilege violations that have been observed; this mode could provide near real-time data for intrusion detection and forensics in the spirit of Transparent Computing. Alternatively, in enforcement mode, any policy violation produces fail-stop behavior.

13.2 Dynamic Analysis Limitations

In one example implementation, SCALPEL uses dynamic analysis to capture the observed low-level operations performed by a program. Observing dynamic behavior is important for SCALPEL to capture performance statistics to build performant policies (Section 7). However, this also means that our captured traces represent a lower bound of the true privileges that might be exercised by a program, which could produce false positives in enforcement mode. There are a number of ways to handle this issue, and SCALPEL is agnostic to that choice. In cases where extensive test suites are available or can be constructed, one might use precise SCALPEL; that is, the traced program behavior serves as a ground truth for well-behaved programs and any violations produce fail-stop behavior; some simpler embedded systems applications may fit into this category. For higher usability on more complex software, SCALPEL could be combined with static analysis techniques for a hybrid policy design. In that case, the policy construction proceeds exactly as described in this paper for capturing important performance effects, but the allowed interactions between Domain-IDs and Object-IDs would be relaxed to the allowed sets as found by static analysis. The best choice among these options will depend on security requirements, the quality and availability of test suites, and the tolerable failure rate of the protected application. We consider these issues orthogonal to SCALPEL's primary contributions.

### 14. Additional Thoughts

SCALPEL is a tool for producing highly-performant compartmentalization policies for the PIPE architecture. The SCALPEL back-end is a policy compiler that automatically lowers compartmentalization policies to the PIPE for hardware-accelerated enforcement. The SCALPEL front-end provides a set of compartment generation algorithms to help a security engineer explore the privilege-performance tradeoff space that can be achieved with the PIPE. The capstone algorithm presented in SCALPEL constructs policies by targeting a limit on the number of rules during each of a program's phases to achieve highly favorable cache characteristics. We show that the same technique can be used to produce designs with predictable runtime characteristics suitable for real-time systems. All together, SCALPEL shows that the PIPE can use fine-grained privilege separation with hundreds of compartments to achieve a very low overprivilege ratio with very low overheads.

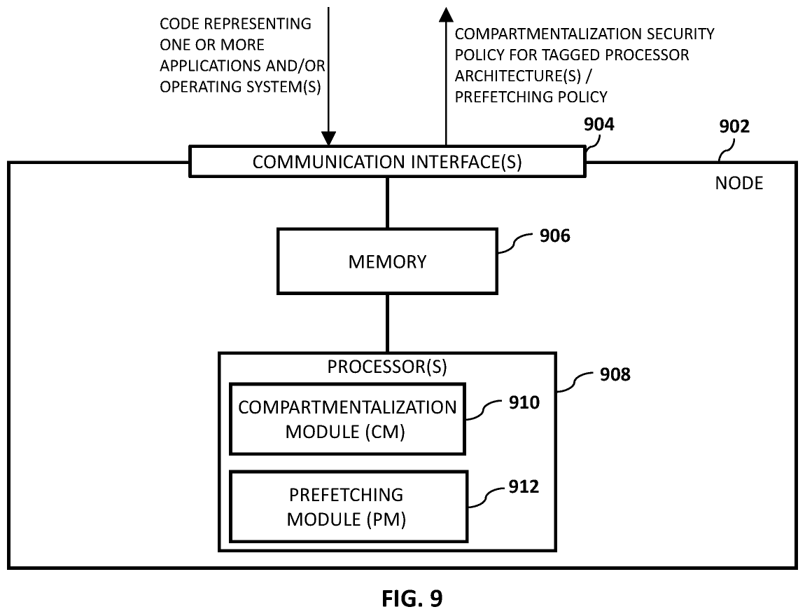

FIG. 9 is a diagram illustrating an exemplary node 902 for generating compartmentalization security policies for tagged processor architectures. Node 902 may be any suitable entities, such as one or more single or multi-processor computing devices or platforms, for performing one or more aspects of the present subject matter described herein. In some embodiments, components, modules, and/or portions of node 902 may be implemented or distributed across multiple devices or computing platforms.

Node 902 may include one or more communications interface(s) 904, a memory 906, and one or more processor(s) 908. Communications interface may be one or more suitable entities (e.g., network interface cards (NICs), communications bus interface, etc.) for receiving, sending, and/or copying messages or data. In some embodiments, communications interface(s) 904 may receive code (e.g., human-readable code like source code and/or computer readable code like machine code or byte code) of an application to be analyzed from a user or one or more data stores. In some embodiments, communications interface(s) 904 may send a compartmentalization security policy (e.g., a set of rules) and/or a prefetching policy that can compiled and implemented on a tagged architecture for hardware-accelerated enforcement.

In some embodiments, communications interface(s) 904 may also include or utilize a user interface, a machine to machine (MIM) interface, an application programming interface (API), and/or a graphical user interface (GUI). For example, some user input, such as additional constraints, may be provided via a user interface and used when generating a compartmentalization security policy. In another example, a node or system may send input or various data via an API or other interface.

Memory 906 may be any suitable entity (e.g., random access memory or flash memory) for storing compartmentalization algorithms, performance metrics, output from tracing policies, Rule-Successor graphs, OR computation logic, monitoring data, system preferences, and/or other information related to generating, optimizing, analyzing, and/or compiling compartmentalization security policies and/or prefetching policies. Various components, such as communications interface(s) 904 and software executing on processor(s) 908, may access memory 906.

Processor(s) 908 represents one or more suitable entities (e.g., a physical processor, a field-programmable gateway array (FPGA), and/or an application-specific integrated circuit (ASIC)) for performing one or more functions associated with generating, optimizing, analyzing, and/or compiling compartmentalization security policies and/or prefetching policies. Processor(s) 908 may be associated with a compartmentalization module (CM) 910 and/or prefetching module (PM) 912. CM 910 may be configured to use various techniques, models, algorithms, and/or data in generating, optimizing, analyzing, and/or compiling compartmentalization security policies. PM 912 may be configured to use various techniques, models, algorithms, and/or data in generating, optimizing, analyzing, and/or compiling rule prefetching policies for rule caches.

In some embodiments, CM 910 may be configured for receiving code (e.g., computer code, executable code, computer instructions, source code, etc.) of at least one application; determining, using a compartmentalization algorithm, at least one rule cache characteristic, and performance analysis information, compartmentalizations for the code and rules for enforcing the compartmentalizations; and generating a compartmentalization security policy comprising the rules for enforcing the compartmentalizations.

In some embodiments, node 902, CM 910, or another node or module may be configured for instantiating, using a policy compiler, a compartmentalization security policy for enforcement in one or more tagged processor architectures. In some embodiments, instantiating a compartmentalization security policy may include tagging an image of code (e.g., a machine code or byte code representation of one or more programs) based on the compartmentalization security policy. For example, tagging an image of code may include adding metadata tags that indicate logical privilege domains or compartments for components of the code. For example, before optimization, each function or object in code may be assigned a unique domain ID, where each domain ID may represent a different logical privilege domain or compartment. In this example, after optimization, some functions or objects may share domain IDs, thereby reducing the number of rules required for enforcement.

In some embodiments, node 902, CM 910, PM 912, or another node or module may be configured for generating a rule prefetching policy for a compartmentalization security policy and providing the rule prefetching policy to at least one policy execution processor (e.g., a PEX core, specialized or dedicated hardware for performing policy execution, a processor for performing policy execution, etc.) for performing rule prefetching during the enforcement of compartmentalization security policy. In such embodiments, the rule prefetching policy may indicate mappings between source rules and sets of related rules to load into the rule cache when a respective source rule triggers a cache miss.

In some embodiments, generating a rule prefetching policy may include monitoring execution of at least one application and generating probabilities of subsequent rules being required after a particular rule triggers a cache miss based on the monitored execution. In such embodiments, the rule prefetching policy may include a mapping of a first rule and a set of probable subsequent rules, wherein the set of probable subsequent rules may be determined using the probabilities and a probability threshold value.

In some embodiments, prefetching policy generation and related application may be usable with other security policies beyond compartmentalization. Examples security policies or related enforcement that can utilize rule prefetching policies may include, but is not limited to, memory safety, control flow, information flow, integrity (code, pointer, data), multi-level security, taint tracking, or composite policies that support a combination of security policies.

In some embodiments, determining compartmentalizations and rules for enforcing the compartmentalizations may comprise executing a compartmentalization algorithm multiple times using different parameter values for determining ORs and/or performance metrics of different versions of a compartmentalization security policy; and selecting a version of the compartmentalization security policy using selection criteria and the ORs and/or the performance metrics (e.g., a compartmentalization security policy is selected based on the lowest OR from all candidate policies that generate 5% overhead or less).

In some embodiments, CM 910 may be configured to work in parallel with a plurality of processors 908. For example, each processor 908 may execute a different version of a compartmentalization algorithm to generate different versions of a compartmentalization security policy concurrently. In this example, after working in parallel to generate the different versions, one instance of CM 910 may be configured to select the best version by analyzing ORs and/or performance metrics associated with the different versions.

In some embodiments, PM 912 may be configured to work in parallel with a plurality of processors 908. For example, a first processor 908 may run an instance of PM 912 for generating a prefetching policy for a first security policy (e.g., integrity policy) and a second processor 908 may run an instance of PM 912 for generating a prefetching policy for a second security policy (e.g., memory safety policy) that is to be enforced concurrently with the first security policy.

It will be appreciated that FIG. 9 is for illustrative purposes and that various nodes, their locations, and/or their functions may be changed, altered, added, or removed. For example, some nodes and/or functions may be combined into a single entity. In a second example, a node and/or function may be located at or implemented by two or more nodes.

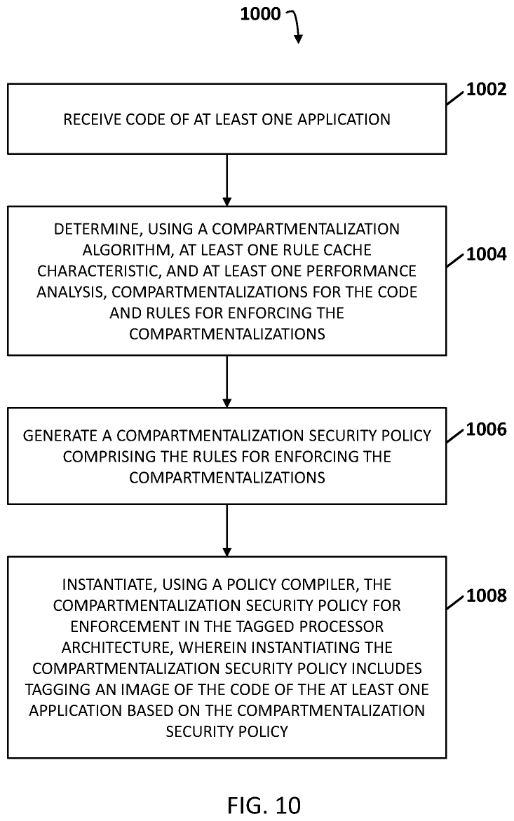

FIG. 10 is a flowchart illustrating an example method 1000 for generating compartmentalization security policies for tagged processor architectures. Method 1000 or portions thereof can be performed at or by node 902, CM 910, PM 912, or another node or module.

In some embodiments, security policies generated by node 902 or CM may be executed by a metadata processing system (e.g., a tagged processor node 1202 discussed below) or related elements for enforcing security policies in a processor architecture (e.g., RISC-V) implemented using one or more processors. In some embodiments, an example metadata processing system can be software executing firmware and/or hardware, e.g., a processor, a microprocessor, a central processing unit, or a system on a chip. In some examples, a metadata processing system for enforcing security policies in a processor architecture may utilize a PUMP system.

In some examples, method 1000 can be executed in a distributed manner. For example, a plurality of processors may be configured for performing method 1000 or portions thereof.

Referring to method 1000, in step 1002, code of at least one application may be received. For example, node 902 may receive computer code (e.g., source code, computer executable or readable code, and/or other computer code) for a web server application running on FreeRTOS.

In step 1004, compartmentalizations for the code and rules for enforcing the compartmentalizations may be determined using a compartmentalization algorithm, at least one rule cache characteristic, and performance analysis information (e.g., information obtained or derived from one or more performance analyses or assessments of the code or application executing). For example, CM 910 may use a tracing policy to collect or learn rule locality information and may use the rule locality information for generating a number of compartmentalizations for some code and a related set of rules for enforcing these compartmentalizations such that the set of rules can fit in a predetermined sized rule cache.

In step 1006, a compartmentalization security policy comprising rules for enforcing a plurality of compartmentalizations may be generated. For example, CM 910 may create a compartmentalization security policy that is to be compiled or instantiating by a policy compiler.

In step 1008, the compartmentalization security policy may be instantiated by a policy compiler for enforcement in the tagged processor architecture, wherein instantiating the compartmentalization security policy includes tagging an image of the code of the at least one application based on the compartmentalization security policy.

In some embodiments, tagging an image of code associated with one or more applications may include adding metadata tags that indicate logical privilege domains or compartments for code components of the code. For example, before optimization, each function or object in code may be assigned a unique domain ID, where each domain ID may represent a different logical privilege domain or compartment. In this example, after optimization, some functions or objects may share domain IDs, thereby reducing the number of rules required for enforcement.

In some embodiments, node 902, CM 910, PM 912, or another node or module may be configured for generating a rule prefetching policy for a particular compartmentalization security policy and providing the rule prefetching policy to at least one policy execution processor (e.g., a processor or specialized or dedicated hardware for performing policy execution, a PEX core, etc.) for performing rule prefetching during the enforcement of compartmentalization security policy. In such embodiments, the rule prefetching policy may indicate mappings between source rules and sets of related rules to load into the rule cache when a respective source rule triggers a cache miss.

In some embodiments, generating a rule prefetching policy may include monitoring execution of at least one application and generating probabilities of subsequent rules being required after a particular rule triggers a cache miss based on the monitored execution. In such embodiments, the rule prefetching policy may include a mapping of a first rule and a set of probable subsequent rules, wherein the set of probable subsequent rules may be determined using the probabilities and a probability threshold value.

In some embodiments, prefetching policy generation and related application may be usable with other security policies beyond compartmentalization. Examples security policies or related enforcement that can utilize rule prefetching policies may include, but is not limited to, memory safety, control flow, information flow, integrity (code, pointer, data), multi-level security, taint tracking, or composite policies that support a combination of security policies.

In some embodiments, a set of probable subsequent rules associated with a first rule (e.g., a source rule) may also be determined using a maximum number or a target number of rules for the set of probable subsequent rules. For example, node 902, CM 910, or another node or module may be configured to generate a rule prefetch policy where the maximum number of a related rules for any source rule is 15.

In some embodiments, a compartmentalization algorithm may include a working-set algorithm that selects, using rule locality information learned from a tracing policy involving monitoring execution of at least one application, a set of rules encountered during a predetermined period of time (e.g., an epoch) as a working-set and reduces the rules in the working-set until a number of rules in the working-set may be equal to or below a maximum number or a target number of rules allowed per working-set by iteratively merging domains using a rule delta calculation.

In some embodiments, a compartmentalization algorithm may use one or more syntactic compartments and/or one or more syntactic constraints when determining the compartmentalizations and the rules for enforcing the compartmentalizations.

In some embodiments, determining compartmentalizations and rules for enforcing the compartmentalizations may comprise executing a compartmentalization algorithm multiple times using different parameter values for determining ORs and/or performance metrics of different versions of a compartmentalization security policy; and selecting a version of the compartmentalization security policy using selection criteria and the ORs and/or the performance metrics (e.g., a compartmentalization security policy is selected based on the lowest OR from all candidate policies that generate 5% overhead or less).

It will be appreciated that method 1000 is for illustrative purposes and that different and/or additional actions may be used. It will also be appreciated that various actions described herein may occur in a different order or sequence.

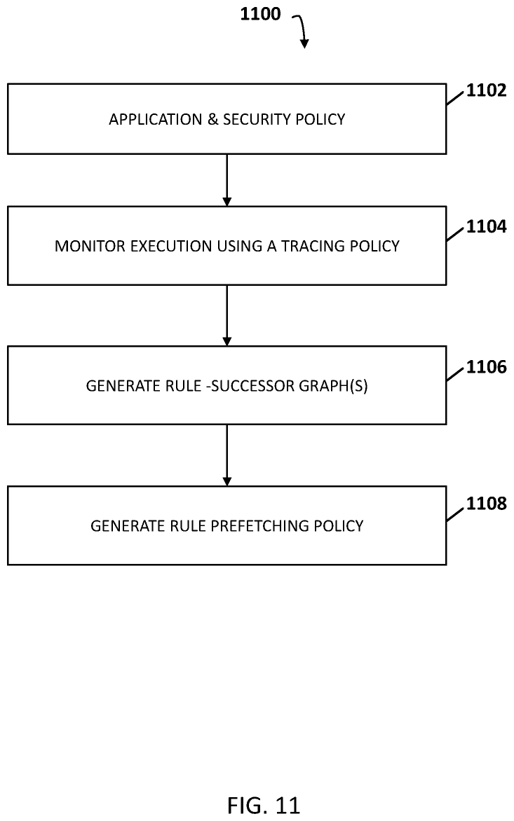

FIG. 11 is a flowchart illustrating an example method 1100 for generating prefetching policies for rule caches associated with tagged processor architectures. Method 1100 or portions thereof can be performed at or by node 902, PM 912, or another node or module.

In some embodiments, prefetching policies generated by node 902 or PM 912 may be executed by a metadata processing system (e.g., a tagged processor architecture like tagged processor node 1202 discussed below) or related elements (e.g., a PEX core) for enforcing security policies in a processor architecture (e.g., RISC-V) implemented using one or more processors. In some embodiments, an example metadata processing system can be software executing firmware and/or hardware, e.g., a processor, a microprocessor, a central processing unit, or a system on a chip. In some examples, a metadata processing system for enforcing security policies in a processor architecture may utilize a PUMP system.

In some embodiments, prefetching policies may also be used by a miss-handling processor.

In some examples, method 1100 can be executed in a distributed manner. For example, a plurality of processors may be configured for performing method 1100 or portions thereof.

Referring to method 1100, in step 1102, code (e.g., computer code) for at least one application and a security policy may be received by a PEX core or another processor for execution tracing.

In step 1104, a tracing policy may be used to monitor executing of the at least one application and the security policy.

In step 1106, output from the tracing policy may be used to generate one or more Rule-Successor Graphs and/or rule probability information.

In step 1108, a rule prefetching policy may be generated using the one or more Rule-Successor Graphs and/or rule probability information.

It will be appreciated that method 1100 is for illustrative purposes and that different and/or additional actions may be used. It will also be appreciated that various actions described herein may occur in a different order or sequence.

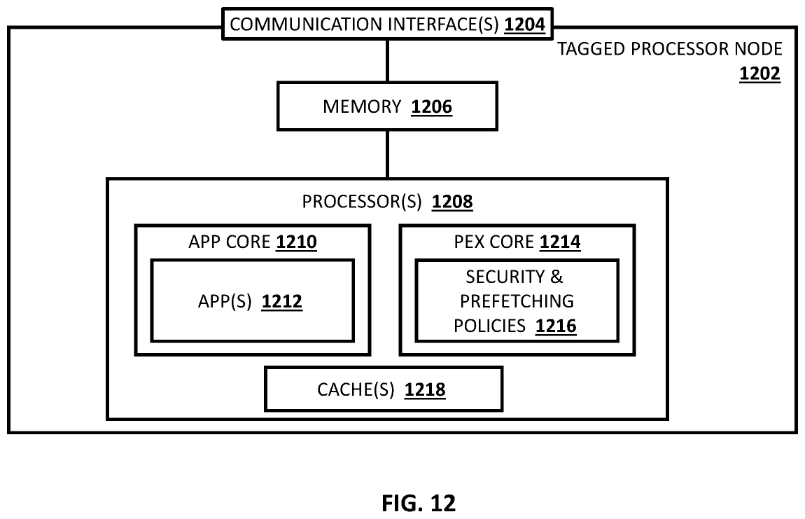

FIG. 12 is a diagram illustrating an example tagged processor node for executing security and prefetching policies. Tagged processor node may be any suitable entities, such as one or more single or multi-processor computing devices or platforms, for performing one or more aspects for hardware-accelerated enforcement of security policies and rule prefetching policies. In some embodiments, components, modules, and/or portions of node 1202 may be implemented or distributed across multiple devices or computing platforms.

Node 1202 may include one or more communications interface(s) 1204, a memory 1206, and one or more processor(s) 1208. Communications interface 1204 may be one or more suitable entities (e.g., NICs, communications bus interface, etc.) for receiving, sending, and/or copying messages or data. In some embodiments, communications interface(s) 1204 may receive computer code (e.g., computer readable code like machine code or byte code) of at least application and a related security policy and rule prefetching policy.

In some embodiments, communications interface(s) 1204 may also include or utilize a user interface, a MIM interface, an API, and/or a GUI. For example, a user may provide input via a GUI. In another example, a node or system may provide input or various data via an API or other interface.

Memory 1206 may be any suitable entity (e.g., random access memory or flash memory) for storing various data related to executing one or more applications and related security and prefetching policies. Various components, such as communications interface(s) 1204 and software executing on processor(s) 1208 or related cores, may access memory 1206.

Processor(s) 1208 represents one or more suitable entities (e.g., a physical processor, an FPGA, and/or an ASIC) for executing one or more applications and related security and prefetching policies. Processor(s) 1208 may include an application core (app core) 1210 for executing one or more application(s) 1212 and an PEX core 1214 for executing a metadata related security policy and a related rule prefetching policy 1218 for prefetching related rules for cache(s) in addition to the rule that triggers the cache miss.

In some embodiments, a rule prefetching policy may be utilized for various types of security policies including, but is not limited to, policies for memory safety, control flow, information flow, integrity (code, pointer, data), multi-level security, taint tracking, and/or combinations thereof.

In some embodiments, a method for generating a rule prefetching policy for a tagged processor architecture comprises: monitoring execution of at least one program for obtaining interactions between objects or functions associated with the program, wherein monitoring execution including tracking probabilities of one or more security rules succeeding each security rule of a security policy; using the probabilities to create associations between source security rules and sets of probable succeeding security rules; and generating a rule prefetching policy containing the associations, wherein each association indicates to a policy execution processor executing the rule prefetching policy that a respective set of probable succeeding security rules are to be loaded into a rule cache when a cache miss operation associated with a respective source security rule occurs.

In some embodiments, a method for executing a rule prefetching policy in a tagged processor architecture comprises: at a policy execution processor: receiving rule prefetching policy containing associations between source security rules and sets of probable succeeding security rules, wherein the sets of probable succeeding security rules are determined by probabilities learned during prior monitored execution of at least one program; and instantiating, using a policy compiler, the rule prefetching policy, wherein instantiating the rule prefetching policy includes: when a cache miss operation associated with a source security rule occurs: determining, using the associations between source security rules and sets of probable succeeding security rules, a set of probable succeeding security rules associated with the source security rule; and loading the set of probable succeeding security rules into a rule cache.

In some embodiments, a method for generating a rule prefetching policy for rule caches associated with tagged processor architectures comprises: generating a rule prefetching policy for a security policy, wherein the rule prefetching policy indicates mappings between source rules and sets of related rules to load into a rule cache when a respective source rule triggers a cache miss; and providing the rule prefetching policy to a policy execution processor for performing rule prefetching while enforcing the security policy by the policy execution processor. In such embodiments, the rule prefetching policy is provided to and used by a miss handling processor.

In some embodiments, a security policy is for enforcing memory safety, control flow, information flow, integrity, multi-level security, taint tracking, or composite policies that support a combination of security policies.

In some embodiments, a method comprises: executing a tracing policy for collecting information about privileges exercised by an application being monitored; and using the collected information for performing code compartmentalizations, security policy optimizations, or other actions.

It will be appreciated that FIG. 12 is for illustrative purposes and that various nodes, their locations, and/or their functions may be changed, altered, added, or removed. For example, some nodes and/or functions may be combined into a single entity. In a second example, a node and/or function may be located at or implemented by two or more nodes.

### REFERENCES

The disclosure of each of the following references is incorporated herein by reference in its entirety to the extent not inconsistent herewith and to the extent that it supplements, explains, provides a background for, or teaches methods, techniques, and/or systems employed herein.
[1] [n.d.]. AppArmor. https://wiki.ubuntu.com/AppArmor. Accessed: 2020-9-11.
[2] [n.d.]. CVE Details: Libxml2 Vulnerability Statistics. https://www.cvedetails.com/product/3311/Xmlsoft-Libxml2.html?vendor id=1962. Accessed: 2020-10-25.
[3] [n.d.]. HTTP Web Server Example. https://freertos.org/FreeRTOS-Plus/FreeRTOS_Plus_TCP/HTTP_web_Server.html. Accessed: 2020-9-30.
[4] [n.d.]. Introduction to SPARC M7 and Application Data Integrity (ADI). https://swisdev.oracle.com/_files/What-Is-ADI.html. Accessed: 2019-12-09.
[5] [n.d.]. The MONDIAL Database. https://www.dbis.informatik.uni-goettingen.de/Mondial.2020.
[6] [n.d.]. The XML C Parser and toolkit of Gnome. http://www.xmlsoft.org/. Accessed: 2020-10-4.
[7] 2018. NXP Selects Dover Microsystems' State-of-the-Art CoreGuard Cybersecurity Technology for Future Embedded Platforms. https://media.nxp.com/news-releases/news-release-details/nxp-selects-dover-microsystems-state-art-coreguard-cybersecurity.
[8] Ali Abbasi, Jos Wetzels, Thorsten Holz, and Sandro Etalle. 2019. Challenges in designing exploit mitigations for deeply embedded systems. In 2019 IEEE European Symposium on Security and Privacy (EuroS&P). IEEE, 31-46.
[9] Daniel Aloise, Amit Deshpande, Pierre Hansen, and Preyas Popat. 2009. NP-hardness of Euclidean sum-of-squares clustering. Machine Learning 75, 2 (1 May 2009), 245-248. https://doi.org/10.1007/s10994-009-5103-0
[10] ARM. 2016. TrustZone technology for ARM v8-M Architecture.
[11] ARM Limited [n.d.]. ARMv8-M Architecture Reference Manual. ARM Limited. 2016.
[12] Arthur Azevedo de Amorim. 2017. A methodology for micro-policies. Ph.D. Dissertation. University of Pennsylvania. http://www.seas.upenn.eduhaarthur/thesis.pdf
[13] Arthur Azevedo de Amorim, Maxime Dénés, Nick Giannarakis, C\check{a}t\check{a}lin Hritcu, Benjamin C. Pierce, Antal Spector-Zabusky, and Andrew Tolmach. 2015. Micro-Policies: Formally Verified, Tag-Based Security Monitors. In 36th IEEE Symposium on Security and Privacy (Oakland S&P). IEEE Computer Society, 813-830. https://doi.org/10.1109/SP.2015.55
[14] Andrea Bittau, Petr Marchenko, Mark Handley, and Brad Karp. 2008. Wedge: Splitting Applications into Reduced-Privilege Compartments. In Proceedings of the 5th USENIX Symposium on Networked Systems Design and Implementation (NSDI'08). USENIX Association, Berkeley, Calif., USA, 309-322.
[15] Shimin Chen, Michael Kozuch, Theodoros Strigkos, Babak Falsafi, Phillip B. Gibbons, Todd C. Mowry, Vijaya Ramachandran, Olatunji Ruwase, Michael P. Ryan, and Evangelos Vlachos. 2008. Flexible Hardware Acceleration for Instruction-Grain Program Monitoring. In 35th International Symposium on Computer Architecture (ISCA). IEEE, 377-388. http://www.cs.cmu.eduhlba/papers/LBA-isca08.pdf
[16] Abraham A. Clements, Naif Saleh Almakhdhub, Saurabh Bagchi, and Mathias Payer. 2018. ACES: Automatic Compartments for Embedded Systems. In 27th USENIX Security Symposium (USENIX Security 2018). USENIX Association, 65-82. https://www.usenix.org/conference/usenixsecurity18/presentation/clements
[17] DARPA. [n.d.]. Transparent Computing. https://www.darpa.mil/program/transparent-computing. Accessed: 2020-9-30.
[18] Daniel Y. Deng and G. Edward Suh. 2012. High-performance parallel accelerator for flexible and efficient run-time monitoring. In IEEE/IFIP International Conference on Dependable Systems and Networks (DSN). IEEE Computer Society, 1-12. http://tsg.ece.cornell.edu/lib/exe/fetch.php?media=pubs:flex-dsn2012.pdf
[19] Udit Dhawan and André DeHon. 2013. Area-Efficient Near-Associative Memories on FPGAs. In Proceedings of the International Symposium on Field-Programmable Gate Arrays. 191-200. http://ic.ese.upenn.edu/abstracts/dmhc_fpga2013.html
[20] Udit Dhawan, C\check{a}t\check{a}lin Hritcu, Rafi Rubin, Nikos Vasilakis, Silviu Chiricescu, Jonathan M. Smith, Thomas F. Knight, Jr., Benjamin C. Pierce, and André DeHon. 2015. Architectural Support for Software-Defined Metadata Processing. In International Conference on Architectural Support for Programming Languages and Operating Systems. 487-502. http://ic.ese.upenn.edu/abstracts/sdmp_asplos2015.html
[21] Xinshu Dong, Hong Hu, Prateek Saxena, and Zhenkai Liang. 2013. A quantitative evaluation of privilege separation in web browser designs. In European Symposium on Research in Computer Security. Springer, 75-93.
[22] Dovecot. [n.d.]. Dovecot Mail Server. https://github.com/dovecot/core. Accessed: 2020-10-12.
[23] Kevin Elphinstone and Gernot Heiser. 2013. From L3 to seL4 What Have We Learnt in 20 Years of L4 Microkernels?. In Proceedings of the ACM Symposium on Operating Systems Principles (Farminton, Pa.) (SOSP '13). ACM, New York, N.Y., USA, 133-150. https://doi.org/10.1145/2517349.2522720
[24] Joseph A Fisher and Stefan M Freudenberger. 1992. Predicting conditional branch directions from previous runs of a program. ACM SIGPLAN Notices 27, 9 (1992), 85-95.
[25] Sotiria Fytraki, Evangelos Vlachos, Yusuf Onur Kogberber, Babak Falsafi, and Boris Grot. 2014. FADE: A programmable filtering accelerator for instruction-grain monitoring. In 20th IEEE International Symposium on High Performance Computer Architecture, HPCA 2014, Orlando, Fla., USA, Feb. 15-19, 2014. 108-119. https://doi.org/10.1109/HPCA.2014.6835922
[26] Khilan Gudka, Robert N. M. Watson, Jonathan Anderson, David Chisnall, Brooks Davis, Ben Laurie, Ilias Marinos, Peter G. Neumann, and Alex Richardson. 2015. Clean Application Compartmentalization with SOAAP. In Proceedings of the 22Nd ACM SIGSAC Conference on Computer and Communications Security (CCS '15). ACM, New York, N.Y., USA, 1016-1031. https://doi.org/10.1145/2810103.2813611
[27] HEX-Five [n.d.]. MultiZone Security Reference Manual. HEX-Five. 2020.
[28] Terry Ching-Hsiang Hsu, Kevin Hoffman, Patrick Eugster, and Mathias Payer. 2016. Enforcing Least Privilege Memory Views for Multithreaded Applications. In ACM Conf on Computer and Communication Security. https://doi.org/10.1145/2976749.2978327
[29] Chung Hwan Kim, Taegyu Kim, Hongjun Choi, Zhongshu Gu, Byoungyoung Lee, Xiangyu Zhang, and Dongyan Xu. 2018. Securing Real-Time Microcontroller Systems through Customized Memory View Switching. In NDSS.
[30] Draper Laboratory. [n.d.]. Hope-tools Github Repository. https://github.com/draperlaboratory/hope-src. Accessed: 2020-10-05.
[31] Jochen Liedtke. 1995. On micro-Kernel Construction. In 15th ACM Symposium on Operating Systems Principles. 237-250.
[32] Arm Limited. [n.d.]. Arm Cortex-A53 Specification. https://developer.arm.com/ip-products/processors/cortex-a/cortex-a53. Accessed: 2020-10-05.
[33] Shen Liu, Dongrui Zeng, Yongzhe Huang, Frank Capobianco, Stephen McCamant, Trent Jaeger, and Gang Tan. 2019. Program-mandering: Quantitative Privilege Separation. In Proceedings of the 2019 ACM SIGSAC Conference on Computer and Communications Security (London, UK) (CCS '19). ACM, New York, N.Y., USA.
[34] Sparsh Mittal. 2016. A survey of recent prefetching techniques for processor caches. ACM Computing Surveys (CSUR) 49, 2 (2016), 1-35.
[35] Gabriel Parmer and Richard West. 2011. Mutable protection domains: Adapting system fault isolation for reliability and efficiency. IEEE Transactions on Software Engineering 38, 4 (2011), 875-888.
[36] Marios Pomonis, Theofilos Petsios, Angelos D. Keromytis, Michalis Polychronakis, and Vasileios P. Kemerlis. 2017. kR\hat{ }X: Comprehensive Kernel Protection against Just-In-Time Code Reuse. In Proc. of EuroSys. 420-436.
[37] Richard F. Rashid and George G. Robertson. 1981. Accent: A Communication Oriented Network Operating System Kernel. In Proceedings of the Eighth ACM Symposium on Operating Systems Principles (Pacific Grove, Calif., USA) (SOSP '81). ACM, New York, N.Y., USA, 64-75. https://doi.org/10.1145/800216.806593
[38] Nick Roessler and André DeHon. 2018. Protecting the Stack with Metadata Policies and Tagged Hardware. In IEEE Symposium on Security and Privacy (Oakland S&P). IEEE Computer Society.
[39] Jerry H. Saltzer and Mike D. Schroeder. 1975. The Protection of Information in Computer Systems. Proc. IEEE 63,9 (September 1975), 1278-1308.
[40] Andreas Sembrant. 2012. Efficient techniques for detecting and exploiting runtime phases. Ph.D. Dissertation. Uppsala University.
[41] Timothy Sherwood, Erez Perelman, Greg Hamerly, Suleyman Sair, and Brad Calder. 2003. Discovering and exploiting program phases. IEEE micro 23,6 (2003), 84-93.
[42] Jia Song. 2014. Security Tagging for a Real-time Zero-kernel Operating System: Implementation and Verification. Ph.D. Dissertation. University of Idaho.
[43] Jia Song and Jim Alves-Foss. 2013. Security Tagging for a Zero-Kernel Operating System. In System Sciences (HICSS), 2013 46th Hawaii International Conference on. IEEE, 5049-5058. http://www.computer.org/csdl/proceedings/hicss/2013/4892/00/4892f049.pdf
[44] Gregory T Sullivan, André DeHon, Steven Milburn, Eli Boling, Marco Ciaffi, Jothy Rosenberg, and Andrew Sutherland. 2017. The Dover inherently secure processor. In 2017 IEEE International Symposium on Technologies for Homeland Security (HST). IEEE, 1-5.
[45] Stylianos Tsampas, Akram El-Korashy, Marco Patrignani, Dominique Devriese, Deepak Garg, and Frank Piessens. 2017. Towards automatic compartmentalization of C programs on capability machines. In Workshop on Foundations of Computer Security 2017.1-14.
[46] R. N. M. Watson, R. M. Norton, J. Woodruff, S. W. Moore, P. G. Neumann, J. Anderson, D. Chisnall, B. Davis, B. Laurie, M. Roe, N. H. Dave, K. Gudka, A. Joannou, A. T. Markettos, E. Maste, S. J. Murdoch, C. Rothwell, S. D. Son, and M. Vadera. 2016. Fast Protection-Domain Crossing in the CHERI Capability-System Architecture. IEEE Micro 36, 5 (September 2016), 38-49. https://doi.org/10.1109/MM.2016.84
[47] Emmett Witchel, Junghwan Rhee, and Krste Asanović. 2005. Mondrix: Memory Isolation for Linux Using Mondriaan Memory Protection. In Proceedings of the Twentieth ACM Symposium on Operating Systems Principles (SOSP '05). ACM, New York, N.Y., USA, 31-44. https://doi.org/10.1145/1095810.1095814
[48] Jonathan Woodruff, Robert N. M. Watson, David Chisnall, Simon W. Moore, Jonathan Anderson, Brooks Davis, Ben Laurie, Peter G. Neumann, Robert Norton, and Michael Roe. 2014. The CHERI capability model: Revisiting RISC in an age of risk. In Proc. of the International Symposium on Computer Architecture (ISCA). 457-468. https://doi.org/10.1109/ISCA.2014.6853201
[49] Nick Roessler and André DeHon. 2021. SCALPEL: Exploring the Limits of Tag-enforced Compartmentalization. J. Emerg. Technol. Comput. Syst. 18, 1, Article 2 (January 2022), 28 pages. https://doi.org/10.1145/3461673
[50] Roessler, Nicholas, “Policy Implementation And Engineering For Tagged Architectures” (2021). Publicly Accessible Penn Dissertations. 4228. https://repository.upenn.edu/edissertations/4228

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for generating compartmentalization security policies for tagged processor architectures, the method comprising:
at a node for generating compartmentalization security policies for enforcement in a tagged processor architecture:
receiving computer code of at least one application;
determining, using a compartmentalization algorithm, at least one rule cache characteristic, and performance analysis information, compartmentalizations for the computer code and rules for enforcing the compartmentalizations;
generating a compartmentalization security policy comprising the rules for enforcing the compartmentalizations; and
instantiating, using a policy compiler, the compartmentalization security policy for enforcement in the tagged processor architecture, wherein instantiating the compartmentalization security policy includes tagging an image of the computer code of the at least one application based on the compartmentalization security policy.

2. The method of claim 1 wherein tagging the image of computer code includes adding metadata tags that indicate logical privilege domains or compartments for computer code components of the computer code; or
wherein tagging the image of computer code includes adding metadata tags that indicate a logical object for newly allocated memory.

3. The method of claim 1 wherein the at least one application includes a user application and/or an operating system for running the user application or other software;
wherein the at least one rule cache characteristic includes a cache capacity, a cache performance, or comparing overprivilege to a fine-grained reference; or
wherein the performance analysis information includes information from a privilege analysis or information from a performance assessment involving comparing execution times on the tagged processor architecture associated with different candidate compartment rule sets.

4. The method of claim 1 comprising:
generating a rule prefetching policy for the compartmentalization security policy, wherein the rule prefetching policy indicates mappings between source rules and sets of related rules to load into the rule cache when a respective source rule triggers a cache miss; and
providing the rule prefetching policy to at least one policy execution processor for performing rule prefetching during the enforcement of compartmentalization security policy.

5. The method of claim 4 wherein generating the rule prefetching policy includes monitoring execution of the at least one application and generating probabilities of subsequent rules being required after a first rule triggers a cache miss based on the monitored execution and wherein the rule prefetching policy includes a mapping of the first rule and a set of probable subsequent rules, wherein the set of probable subsequent rules is determined using the probabilities and a probability threshold value.

6. The method of claim 5 wherein the set of probable subsequent rules is also determined using a maximum number or a target number of rules for the set of probable subsequent rules.

7. The method of claim 1 wherein the compartmentalization algorithm includes a working-set algorithm that selects, using rule locality information learned from a tracing policy involving monitoring execution of the at least one application, a set of rules encountered during a predetermined period of time as a working-set and reduces the rules in the working-set until a number of rules in the working-set is equal to or below a maximum number or a target number of rules allowed per working-set by iteratively merging domains using a rule delta calculation; or
wherein the compartmentalization algorithm includes a working-set algorithm that selects a set of rules encountered during a predetermined period of time as a working-set and reduces the rules in the working-set based on privilege effects and rule count effects.

8. The method of claim 1 wherein the compartmentalization algorithm uses one or more syntactic compartments and/or one or more syntactic constraints when determining the compartmentalizations and the rules for enforcing the compartmentalization.

9. The method of claim 1 wherein determining the compartmentalizations and rules for enforcing the compartmentalizations comprises:
executing the compartmentalization algorithm multiple times using different parameter values for determining overprivilege ratios and/or performance metrics of different versions of the compartmentalization security policy; and
selecting a version of the compartmentalization security policy determined using selection criteria and the overprivilege ratios and/or the performance metrics.

10. A system for generating compartmentalization security policies for tagged processor architectures, the system comprising:
one or more processors; and
a node for generating compartmentalization security policies for tagged processor architectures implemented using the one or more processors and configured for:
receiving computer code of at least one application;
determining, using a compartmentalization algorithm, at least one rule cache characteristic, and performance analysis information, compartmentalizations for the computer code and rules for enforcing the compartmentalizations;
generating a compartmentalization security policy comprising the rules for enforcing the compartmentalizations; and
instantiating, using a policy compiler, the compartmentalization security policy for enforcement in the tagged processor architecture, wherein instantiating the compartmentalization security policy includes tagging an image of the computer code of the at least one application based on the compartmentalization security policy.

11. The system of claim 10 wherein the policy compiler is configured for tagging the image of the computer code by adding metadata tags that indicate logical privilege domains or compartments for computer code components of the computer code; or
wherein tagging the image of computer code includes adding metadata tags that indicate a logical object for newly allocated memory.

12. The system of claim 10 wherein the at least one application includes a user application and/or an operating system for running the user application or other software;
wherein the at least one rule cache characteristic includes a cache capacity, a cache performance, or comparing overprivilege to a fine-grained reference; or
wherein the performance analysis information includes information from a privilege analysis or information from a performance assessment involving comparing execution times on the tagged processor architecture associated with different candidate compartment rule sets.

13. The system of claim 10 wherein the node is further configured for:
generating a rule prefetching policy for the compartmentalization security policy, wherein the rule prefetching policy indicates mappings between source rules and sets of related rules to load into the rule cache when a respective source rule triggers a cache miss; and
providing the rule prefetching policy to at least one policy execution processor for performing rule prefetching during the enforcement of compartmentalization security policy.

14. The system of claim 13 wherein the node is configured for generating the rule prefetching policy by monitoring execution of the at least one application and generating probabilities of subsequent rules being required after a first rule triggers a cache miss based on the monitored execution and wherein the rule prefetching policy includes a mapping of the first rule and a set of probable subsequent rules, wherein the set of probable subsequent rules is determined using the probabilities and a probability threshold value.

15. The system of claim 14 wherein the set of probable subsequent rules is also determined using a maximum number or a target number of rules for the set of probable subsequent rules.

16. The system of claim 10 wherein the compartmentalization algorithm includes a working-set algorithm that selects, using rule locality information learned from a tracing policy involving monitoring execution of the at least one application, a set of rules encountered during a predetermined period of time as a working-set and reduces the rules in the working-set until a number of rules in the working-set is equal to or below a maximum number or a target number of rules allowed per working-set by iteratively merging domains using a rule delta calculation; or
wherein the compartmentalization algorithm includes a working-set algorithm that selects a set of rules encountered during a predetermined period of time as a working-set and reduces the rules in the working-set based on privilege effects and rule count effects.

17. The system of claim 10 wherein the compartmentalization algorithm uses one or more syntactic compartments and/or one or more syntactic constraints when determining the compartmentalizations and the rules for enforcing the compartmentalizations.

18. The system of claim 10 wherein the node is configured for determining the compartmentalizations and rules for enforcing the compartmentalizations by:
executing the compartmentalization algorithm multiple times using different parameter values for determining overprivilege ratios and/or performance metrics of different versions of the compartmentalization security policy; and
selecting a version of the compartmentalization security policy using selection criteria and the overprivilege ratios and/or the performance metrics.

19. A non-transitory computer readable medium storing executable instructions that when executed by at least one processor of a computer control the computer to perform operations comprising:
at a node for generating compartmentalization security policies for tagged processor architectures implemented using the one or more processors and configured to perform operations comprising:
receiving computer code of at least one application;
determining, using a compartmentalization algorithm, at least one rule cache characteristic, and performance analysis information, compartmentalizations for the computer code and rules for enforcing the compartmentalizations;
generating a compartmentalization security policy comprising the rules for enforcing the compartmentalizations; and
instantiating, using a policy compiler, the compartmentalization security policy for enforcement in the tagged processor architecture, wherein instantiating the compartmentalization security policy includes tagging am image of the computer code of the at least one application based on the compartmentalization security policy.

20. The non-transitory computer readable medium of claim 19 wherein tagging the image of the computer code includes adding metadata tags that indicate logical privilege domains or compartments for computer code components of the computer code.
